(19) United States
(12) Patent Application Publication
(10) Pub. No.: US 2007/0222915 A1
(43) Pub. Date: Sep. 27, 2007

(54) OPTICAL ELEMENT, DISPLAY DEVICE, AND TERMINAL DEVICE

(75) Inventors: Shinya NIIOKA, Tokyo (JP); Shin-ichi Uehara, Tokyo (JP); Ken Sumiyoshi, Tokyo (JP); Setsuo Kaneko, Tokyo (JP)

Correspondence Address: SUGHRUE MION, PLLC, 2100 PENNSYLVANIA AVENUE, N.W., SUITE 800, WASHINGTON, DC, 20037, US

(73) Assignees: NEC CORPORATION, Tokyo (JP); NEC LCD TECHNOLOGIES, LTD., Kawasaki (JP)

(21) Appl. No.: 11/688,134

(22) Filed: Mar. 19, 2007

(30) Foreign Application Priority Data
Mar. 20, 2006 (JP) 2006-076957

(51) Int. Cl. G02F 1/1335

(52) U.S. Cl. 349/62

(57) ABSTRACT

A plurality of pixels is arranged periodically in the x-axis direction and the y-axis direction in the display panel of a display device, and because light is blocked by the portion other than the open part in each pixel, the display panel has a two-dimensional lattice structure. The pixels are rectangular, and the length Px of the long edges in the x direction is larger than the length Py of the short edges in the y direction. A louver, in which transparent regions and non-transparent regions are arranged periodically in a one-dimensional direction, is provided on the display panel, and the angle formed by the x axis and the one-dimensional period direction of the louver is 45 degrees or less, and preferably 10 degrees or less. This configuration makes it possible to obtain an optical element having high directivity, reduced moiré, and high transmittance. It is also possible to obtain a display device having excellent display quality into which the optical element is incorporated.

### BACKGROUND OF THE INVENTION

1. Field of the Invention

The present invention relates to a display device that produces excellent display quality with reduced moiré.

2. Description of the Related Art

Due to recent advances in technology, display panels have been deployed in a range of devices that includes monitors, television sets, and other large terminal devices; notebook PCs (Personal Computer), cash dispensers, vending machines, and other mid-sized terminal devices; and personal TVs (Television), PDAs (Personal Digital Assistant: personal information terminal), mobile telephones, mobile gaming devices, and other small terminal devices that are used in a variety of locations. Because of their thin profile, light weight, small size, low energy consumption, and other advantages, display devices that use liquid crystals are particularly common in terminal devices.

Among these terminal devices, small-to-medium-sized terminal devices are characteristically used not only in closed rooms under tight security, but also in public places. It then becomes necessary to keep displays of private information and confidential information from being viewed by a third party. Particularly in recent years, occasions where private information and confidential information are displayed have increased in conjunction with the development of terminal devices, and demand is increasing for techniques that prevent surreptitious viewing. A display device in which the display can be viewed only by a user positioned in front or in another specific direction, and surreptitious viewing from other directions is prevented by narrowing the range of angles in which the display is visible has been proposed together with an optical member for preventing surreptitious viewing that is applied to this display device.

FIG. 1 is a schematic sectional view showing the conventional privacy enabling device disclosed in Japanese Patent Application Laid-Open No. 2003-131202. As shown in FIG. 1, the conventional privacy enabling device has a thin anti-glare layer 1101; a thin, highly translucent adhesive layer 1110 bonded to the back surface of the anti-glare layer 1101; and a thin translucent layer 1130 integrally bonded to the surface of the anti-glare layer 1101 via a translucent silicone bonding layer 1120. The anti-glare layer 1101, the adhesive layer 1110, and the translucent layer 1130 are each in the form of a flexible sheet or film.

The anti-glare layer 1101 is formed by integrating a plurality of transparent silicone rubber sheets 1102 and a plurality of colored silicone rubber sheets 1103 arranged in alternating fashion in the transverse direction. The adjoining surfaces of the transparent silicone rubber sheets 1102 and colored silicone rubber sheets 1103 are parallel to each other. The adhesive layer 1110 is detachably affixed on a liquid crystal display of an information display not shown in the drawing, and the affixing surface of the adhesive layer 1110 is formed by a smooth translucent adherent surface 1111 that has a mirrored finish.

The width (thickness in the lateral direction of FIG. 1) of the transparent silicone rubber sheets 1102 and colored silicone rubber sheets 1103 is selected with consideration for the fact that the transparency and parallel light transmittance of the anti-glare layer 1101 are determined by the ratio of the width of the transparent silicone rubber sheets 1102 to the width of the colored silicone rubber sheets 1103, and for the fact that the range of viewing angles is determined by the refractive index and width of the transparent silicone rubber sheets 1102 and the overall thickness of the privacy enabling device. Specifically, the transparent silicone rubber sheets 1102 are formed so as to have a width of 100 to 200 μm, preferably 120 to 150 μm. The colored silicone rubber sheets 1103 are formed so as to have a width of 10 to 50 μm, preferably 10 to 30 μm. When the widths of the transparent silicone rubber sheets 1102 and the colored silicone rubber sheets 1103 have these numerical values, the anti-glare layer 1101 can be endowed with transparency and a parallel light transmittance of substantially 80% or higher, or 85% or higher at maximum, and a visible angle range of 90 to 120 degrees.

This conventional privacy enabling device of an information display is formed so as to have a thickness of about 0.15 to 0.5 mm, which takes into account the visible angle range, translucency, and handling properties. A thickness of about 0.15 to 0.3 mm is more preferred in terms of affixing the privacy enabling device to the liquid crystal display of a small-sized, thin mobile telephone or the like.

In the configuration described above, light that enters the privacy enabling device at an angle is absorbed by the louver structure formed by the colored silicone rubber sheets 1103, and therefore does not exit the privacy enabling device. Specifically, the anti-glare layer 1101 has the effect of preventing surreptitious viewing. For example, it is thereby impossible or extremely difficult for a third party present beside the user to see from the side or read the information displayed when the anti-eavesdropping device is mounted on the liquid crystal display of the information display. Accordingly, since the information displayed on the information display is not leaked to a third party, the user of the information display can monitor or transmit information comfortably without worrying about surreptitious viewing.

FIG. 3 is a schematic perspective view showing the conventional display device provided with a directional optical filter for prevention of surreptitious viewing disclosed in Japanese Patent Application Laid-Open No. 60-159702; and FIG. 2 is a top view showing the placement of the directional optical filter in relation to the display surface of the display device. As shown in FIG. 3, the conventional display device provided with a directional optical filter is composed of the directional optical filter 2141 and a shadow mask CRT (Cathode Ray Tube) 2147, wherein the directional optical filter 2147 has transparent filter sheets 2143, 2145 having a plurality of light-absorbing surfaces in the interior thereof. The transparent filter sheets 2143, 2145 are placed between a pair of additional transparent sheets 2151, 2152 in order to give structural strength to the transparent filter sheets 2143, 2145.

The transparent filter sheets 2143, 2145 have a plurality of light-absorbing surfaces in the interior thereof, and the light-absorbing surfaces are arranged so as to block light that enters the transparent filter sheets 2143, 2145 at or above a certain angle. Furthermore, the transparent filter sheets 2143, 2145 are arranged so that the light absorption axes thereof are orthogonal to each other.

As shown in FIG. 2, a plurality of pixels is arranged in the display surface of the shadow mask CRT, and the pixels are phosphor dots 2113 created by the shadow mask and a coating of a phosphorescent substance. The phosphor dots 2113 are arranged at equal intervals along a plurality of horizontal rows 2117, 2118, 2119, and groups of horizontal rows are placed in a regularly repeating arrangement. The phosphor dots 2113 also form a plurality of groups of three dots spaced an equal distance apart, and the centers of the phosphor dots 2113 in each group form the apex points of an equilateral triangle. Each of the three dots displays a different primary color of light, such as red, green, or blue. Accordingly, the relationship in which the phosphor dots are arranged in the horizontal rows 2117, 2118, 2119 is such that a line 2121 is formed that is tilted at an angle of 60 degrees in relation to a horizontal line 2123 that extends horizontally between the phosphor dots. The light absorption axis of the transparent sheet 2143 is set as a line 2131 that is tilted at an angle of 15 degrees in relation to the horizontal line 2123, and the light absorption axis of the transparent sheet 2145 is set as a line 2133 that is tilted at an angle of 75 degrees in relation to the horizontal line 2123.

In the display device provided with a directional optical filter in the configuration described above, a line 2125 that is tilted at an angle of 45 degrees in relation to the horizontal line 2123 passes through a single phosphor dot 2113 in the horizontal row 2117, and intersects with the center of a phosphor dot 2113 in the next row 2119 whose phosphor dots are aligned in the vertical direction with those of the horizontal row 2117. The vertical line 2127 can be described in the same manner. In the same manner, any line that is parallel to a line passing through the phosphor dots 2113 of a specific group always intersects the dots in the same positions. Accordingly, when light from a phosphor dot 2113 is blocked that is aligned with a line parallel to any of lines 2121 through 2127, a regular pattern of light blockage is formed along the line. In contrast, the light absorption axis of the transparent filter sheet 2143 is set as a line 2131 that is tilted at an angle of 15 degrees in relation to the horizontal line 2123, and the light absorption axis of the transparent sheet 2145 is set as a line 2133 that is tilted at an angle of 75 degrees in relation to the horizontal line 2123. Therefore, a regular pattern of light blockage does not occur. The formation of a moiré pattern in the display surface of the CRT is thereby suppressed.

In the display device provided with a directional optical filter in the configuration described above, moiréis reduced, and display quality is enhanced by tilting the structure direction of the directional optical filter in relation to the arrangement direction of the pixels.

FIG. 4 is a schematic structural diagram showing a conventional raster display device provided with a light control film disclosed in Japanese Patent No. 2622762; FIG. 5 is a top view showing the positioning of the light control film with respect to the display surface of the display device; and FIG. 6 is a graph showing the relationship between the pitch p of the moiré stripes, and the angle β between the raster of the display device and the stripes of the light control film.

As shown in FIG. 4, the conventional raster display device provided with a light control film is installed in an in-vehicle information display system, for example, and the in-vehicle information display system is composed of a vehicle state detection device 3101, a CRT display device or other raster display device 3102 having a raster aligned so that the pitch is a, an information display controller 3103 for generating a video signal for display on the basis of the detected vehicle state, a light control film 3104 for controlling incident light, and an operating input device 3106. The light control film 3104 is disposed on the front surface of the raster display device 3102. The user is indicated by reference numeral 3105.

The light control film 3104 controls incident light, and has light-transmitting and light-blocking portions arranged in alternating stripes at a prescribed pitch therein. The light control film 3104 is also arranged so that the direction in which the stripes extend is tilted a prescribed angle β, for example, about 10 degrees, with respect to the raster direction of the raster display device. The pitch of the stripes with respect to the pitch a of the raster herein is a×k. As shown in FIG. 5, a moiré bar whose pitch is p occurs at the intersection between the raster (indicated by straight line A) and the stripe (indicated by straight line B) when the raster display device 3102 and the light control film 3104 are viewed from the front. This moiré bar is indicated by the dotted line C. When the angle β formed by the extension direction of the raster and the extension direction of the stripes is relatively small, the pitch p of the moiré bar can be computed using Eq. 1 below.

p=|a×k/cos(β)|/√(tan(β)²+(1−k/cos(β)²) Eq. 1

FIG. 6 shows an example of the computed pitch p (mm) of the moiré bar when β is a variable, and k is a parameter. As shown in FIG. 6, the pitch p of the moiré bar decreases as the angle β increases, regardless of the size of k. By making the pitch p of the moiré bar about the same or smaller than the pitch of the raster, the moiré bar can be made less visible to the user. When the pitch a of the raster ranges from several tenths of a millimeter to several millimeters, the angle β must be greater than about 3 degrees in order for the pitch p to be less than several millimeters. However, since the light control film must be cut at an angle, the efficiency of the manufacturing process declines when the angle β is too large.

In an image display device for displaying an arbitrary image in which a plurality of pixels is arranged in a two-dimensional/periodic pattern, and an information display device provided with a control film in which light-transmitting portions and light-blocking portions are alternately arranged in stripes at a prescribed pitch on the display surface of the image display device, the pitch of the moiré bar can be reduced, and a display pattern in which good visibility is maintained can be recognized by a user without discomfort by tilting the extension direction of the control film stripes three degrees or more with respect to the arrangement direction of the pixels of the image display device.

FIG. 7 is a schematic sectional view showing the conventional viewing-angle-controlled liquid crystal display device described in Japanese Patent Application Laid-Open No. 9-244018; FIG. 8 is a schematic perspective view showing the illumination device used in the conventional viewing-angle-controlled liquid crystal display device described in Japanese Patent Application Laid-Open No. 9-244018; and FIG. 9 is a schematic perspective view showing the conventional viewing-angle-controlled liquid crystal display device described in Japanese Patent Application Laid-Open No. 9-244018.

As shown in FIG. 8, the conventional viewing-angle-controlled liquid crystal display device 4101 is composed of a liquid crystal display element 4102, a scatter control element (scattering control device) 4103, and an illumination device (backlight) 4104. The scatter control element 4103 is disposed between the liquid crystal display element 4102 and the illumination device 4104. As shown in FIG. 8, the illumination device 4104 is disposed below the scatter control element 4103 and is provided with a light-blocking slitted sheet (translucent sheet) 4120 and an illumination unit 4121. A fluorescent tube or other light source 4122 is provided to the illumination unit 4121, and there are also provided a light-exiting surface 4123 for emitting the light from the light source 4122 and guiding the light to the light-blocking slitted sheet 4120; and a reflecting sheet 4124 disposed on the surface that faces the light-exiting surface 4123, for reflecting the light from the light source 4122. In the light-blocking slitted sheet 4120, numerous light-blocking members are arranged parallel to each other on one surface of a translucent sheet. The direction in which the light-blocking members extend coincides with the direction perpendicular to the display unit. The conventional viewing-angle-controlled liquid crystal display device 4101 is thus configured so that the scatter control element 4103 is disposed between the liquid crystal display element 4102 and the light-blocking slitted sheet (translucent sheet) 4120 (see FIG. 9).

In a conventional viewing-angle-controlled liquid crystal display device configured as described in Japanese Patent Application Laid-Open No. 9-244018, light generated from the light source 4122 is emitted from the light-exiting surface 4123 of the illumination unit 4121, and is radiated to the scatter control element 4103 via the light-blocking slitted sheet 4120. When light emitted from the light-exiting surface 4123 passes through the light-blocking slitted sheet 4120, the light-blocking slitted sheet 4120 blocks light that is incident from directions that are significantly tilted with respect to the light-incident surface, in order to increase the parallelism of the transmitted light. Specifically, transmitted light is thereby obtained that is highly parallel to the direction perpendicular to the surface of the light-blocking slitted sheet 4120. The light emitted from the illumination device 4104 then enters the scatter control element 4103. The scatter control element 4103 controls the scattering properties of the incident light rays according to the presence of an applied voltage. When the scatter control element 4103 is in a scattering state, the light emitted from the illumination device 4104 is scattered by the scatter control element 4103, whereas when the scatter control element 4103 is in a transparent state, the light from the illumination device 4104 is not scattered.

In the viewing-angle-controlled liquid crystal display device 4101 configured as described above, the highly collimated light emitted from the illumination device 4104 is scattered by the scatter control element 4103 and caused to enter the liquid crystal display element 4102 when the scatter control element 4103 is in the scattering state. As a result, the light that has passed through the liquid crystal display element 4102 is released in all directions in the viewing angle of the display unit, and it is possible to recognize the displayed content also from positions other than the position directly in front of the display unit. In contrast, when the scatter control element 4103 is in the transparent state, the highly collimated light emitted from the illumination device 4104 is caused to enter the liquid crystal display element 4102 while still maintaining a high degree of collimation, without being scattered by the scatter control element 4103. As a result, light is not transmitted to positions where the display unit is viewed at an angle to the left or right in the horizontal direction, the screen is darkened when viewed from such a position, and it becomes impossible to recognize the displayed content. In other words, only an observer who is directly facing the display unit can recognize the displayed content.

As described above, since the scattering properties of the light can be controlled by the scatter control element 4103 in the conventional viewing-angle-controlled liquid crystal display device 4101, the viewing angle characteristics of the displayed content can be controlled. Furthermore, since highly collimated light can be emitted towards the liquid crystal display element 4102 by the illumination device 4104, it is possible to reliably obtain viewing angle characteristics in which only an observer directly facing the display unit can recognize the displayed content when the scatter control element 4103 is placed in the transparent state. Consequently, it is possible to obtain a liquid crystal display device that is capable of arbitrarily switching between a state in which display characteristics are uniformly maintained in all viewing angle directions with little dependence on viewing angle, and a state in which the displayed content can be recognized only from a position directly facing the display unit.

However, the conventional techniques described above have such problems as those described below.

Specifically, in the conventional display device provided with a privacy enabling device described in Japanese Patent Application Laid-Open No. 2003-131202, significant moiré is created by the pixels of the display device and the colored silicone rubber sheets constituting the privacy enabling device that is the light-direction regulating element, and display quality is significantly reduced.

A conventional technique for creating a high-directivity display involves providing the display panel with a louver in which transparent parts and light-blocking parts are in a one-dimensional arrangement, but the louver structure and the pixel structure create moiré, and display quality is reduced. Moiré is effectively reduced by applying a louver, whose pitch is smaller than the period of the pixel structure, in the direction in which the louver structure of the display panel is arranged. However, a conventional display panel has a vertical stripe structure, and the period of the pixel structure is therefore small. As a result, the pitch of the louver must be reduced, but since the thickness of the light-blocking parts has a lower limit, the ratio of the light-blocking parts in the louver increases, and transmittance is reduced.

By contrast, in the conventional display device provided with a directional optical filter described in Japanese Patent Application Laid-Open No. 60-159702, moiréis reduced and display quality is enhanced by tilting the light absorption surface of the directional optical filter (which acts as a light-direction regulating element) with respect to the pixel rows. In this arrangement in which the light-direction regulating element is tilted with respect to the pixel rows of the display device, moiré can be reduced and display quality can be enhanced in the same manner as by the conventional display device provided with a light control filter described in Japanese Patent No. 2622762. However, as is also mentioned in Japanese Patent No. 2622762, the light-direction regulating element must be cut at an angle, and the efficiency of the manufacturing process therefore decreases as the angle of the tilted arrangement increases. When this angle is increased, the direction in which surreptitious viewing is prevented also becomes tilted from the vertical and horizontal directions, thereby causing discomfort to the user. It is for these reasons that a tilted arrangement at a large angle is actually impossible to create, and moiré thus cannot be adequately reduced. Furthermore, as shown in FIG. 6, when the pitch of the light-blocking layer of the light-direction regulating element is close to the pixel pitch of the display device, the moiré period becomes larger, and the moiré therefore cannot be adequately reduced even by the tilted arrangement.

The same problems always occur in a display device that has as a constituent element a light-direction regulating element in which transparent regions for transmitting light, and absorbing regions for absorbing light, are formed so as to alternate in the direction perpendicular to the light regulation direction. Specifically, the same problems also occur in the conventional viewing-angle-controlled liquid crystal display device described in Japanese Patent Application Laid-Open No. 9-244018.

### SUMMARY OF THE INVENTION

An object of the present invention is to provide an optical element that reduces moiré and has high directivity and transmittance, to provide a display device having excellent display quality into which the optical element is incorporated, and to provide a terminal device that comprises the display device.

The optical element according to the present invention comprises a two-dimensional lattice sheet composed of transparent regions and non-transparent regions that are periodically arranged in alternating fashion in a first direction and a second direction that intersects the first direction; and a light-direction regulating element that is superposed on the two-dimensional lattice sheet and is composed of transparent regions and non-transparent regions periodically arranged in alternating fashion in a third direction parallel to a surface of the two-dimensional lattice sheet; wherein a minimum cycle in the first direction of the two-dimensional lattice sheet is larger than a minimum cycle in the second direction; and a first primitive translation vector in the first direction whose size is the minimum cycle in the first direction of the two-dimensional lattice sheet, a second primitive translation vector in the second direction whose size is the minimum cycle of the second direction of the two-dimensional lattice sheet, and a third primitive translation vector in the third direction whose size is the minimum cycle in the third direction of the light-direction regulating element are related so that an angle between the third primitive translation vector and the first primitive translation vector is equal to one-half or less of an angle between the first primitive translation vector and the second primitive translation vector.

The light-direction regulating element may have periodic properties whereby transparent regions and non-transparent regions are arranged in alternating fashion in a fourth direction that intersects the third direction and is parallel to a surface of the two-dimensional lattice sheet; a minimum cycle in the fourth direction of the light-direction regulating element may be larger than a minimum cycle in the third direction; and an angle between the second primitive translation vector and a fourth primitive translation vector in the fourth direction whose size is the minimum cycle in the fourth direction of the light-direction regulating element may be one-half or less of an angle between the first primitive translation vector and the second primitive translation vector.

The display device according to the present invention has the optical element; the two-dimensional lattice sheet is a display panel; and the light-direction regulating element is a louver.

The display panel has a plurality of pixels periodically arranged in two dimensions within the display plane, and light is blocked in the portion other than the open part of each pixel. The typical structure of the pixels can therefore be treated as a two-dimensional lattice. The display device of the present application makes it possible to reduce moiré stripes and maintain high transmittance and luminance. The directivity of light emitted or reflected from the display panel can be increased by the louver, and surreptitious viewing can therefore be prevented.

The display panel may be a reflective liquid crystal panel or a self-luminous display panel. The display device may also be configured so that the louver and the display panel are arranged in the following sequence from the direction of an observer: louver, display panel. The louver can thereby be conveniently placed on the display surface, and assembly and manufacturing are therefore facilitated. A backlight or the like is also unnecessary, and the thickness of the assembly can therefore be reduced.

The display device may have a backlight, and the display panel may be a transmissive liquid crystal panel or a transflective liquid crystal panel. The display device may also be configured so that the louver and the display panel are arranged in the following sequence from the direction of an observer: louver, display panel. The louver can thereby be conveniently placed on the display surface, and assembly and manufacturing can therefore be facilitated. The display panel, the louver, and the backlight may also be arranged in the following sequence from the direction of an observer: display panel, louver, backlight. Since the louver is thereby disposed on the back side of the display panel, it is possible to reduce the discomfort caused by an image display that appears to be recessed into the device by an amount commensurate with the thickness of the louver, in comparison to an arrangement in which the louver is disposed in front of the display panel.

A configuration may be adopted in which the display panel has a display region in which pixels are arranged in a matrix, the transparent regions of the two-dimensional lattice sheet are open parts of the pixels, and the non-transparent regions constitute a black matrix having light-blocking properties that is formed in the pixels.

A suitable configuration is one in which the display panel is composed of sub-pixels having color filters in a display surface; a striped color pattern is formed by the color filters; the display panel divided into a lattice by the sub-pixels has two-dimensional translational symmetry in which long edges and short edges of the sub-pixels constitute a period; and an angle of 80 to 100 degrees is formed by a periodic arrangement direction of the striped pattern and a larger primitive translation vector of two primitive translation vectors having two-dimensional translational symmetry. It is also more suitable that a periodic arrangement direction of the striped pattern be orthogonal to the larger primitive translation vector. Because a single pixel is composed of a plurality of sub-pixels divided according to the number of color filter colors, and each sub-pixel is composed of an open part and a light-blocking portion, the typical structure of the sub-pixels can be treated as a two-dimensional lattice. The primitive translation vector having the larger size, and the periodic arrangement direction of the color filter stripe pattern, are also substantially orthogonal. Colored moiréstripes caused by the two-dimensional color arrangement of the color filter and the one-dimensional periodic arrangement of the transparent/non-transparent regions of the louver are thereby suppressed and high transmittance and luminance can thereby be maintained.

The display panel pixels may be composed of four or more colors of sub-pixels. For example, this configuration may be applied in a four-color stripe pattern composed of red (R), green (G), blue (B), and white (W) in square pixels divided into four parts. In this case, the shape of the divided sub-pixels is a rectangle formed by dividing a square into four equal parts using parallel lines. Accordingly, the two primitive translation vectors of the two-dimensional lattice formed by the sub-pixels have different sizes. By applying white (W) pixels in particular, the transmittance of the panel can be enhanced, the luminance can be increased, and the amount of power consumed by the backlight can therefore be reduced.

A configuration may be adopted in which the display panel has color filters composed of three or more colors in a display surface; two or more sub-pixels are provided with respect to a single type of color disposed within a single pixel; and each sub-pixel is individually controlled by an independent display signal. Since contrast can thereby be enhanced without directly increasing the saturation of the color filters, the cost can be reduced, and a superior display device can be provided that is capable of producing more color tones.

In a suitable configuration, the display panel is a liquid crystal panel; periodically arranged structures are provided for dividing and orienting liquid crystals in open parts of pixels; and an angle of 80 to 100 degrees is formed by the periodic arrangement direction and the third direction. Such a structure is sometimes provided to the pixels of a wide-viewing-angle liquid crystal display device, but because the pitch of the structures provided in the pixels is usually smaller than the size of the sub-pixels, an additional short period occurs, and new moiréstripes occur when the display panel is laminated with the louver. The configuration described above reduces these moiré stripes and makes it possible to provide excellent display quality.

In a suitable configuration, the display panel is an in-plane switching liquid crystal panel; electrodes are provided in periodic fashion for generating an in-plane field or an out-of-plane field in open parts of pixels; and an angle of 80 to 100 degrees is formed by the periodic arrangement direction and the third direction. The electrodes provided in periodic fashion to the open parts of the pixels cause an additional short period to occur, and new moiré stripes can occur when the display panel is laminated with the louver. The configuration described above reduces these moiré stripes and makes it possible to provide excellent display quality.

The display device may comprise a transparent/scattering switching element capable of switching between a state of transmitting incident light and a state of scattering incident light. Switching the transparent/scattering switching element between the transparent state and the scattering state makes it possible to vary the range of angles at which the display is visible, provide a viewing-angle-switchable display device, reduce the appearance of moiré stripes particularly in the transparent state, and provide excellent display quality.

The display device may also be a transmissive liquid crystal display device or transflective liquid crystal display device, wherein the display panel, the transparent/scattering switching element, the louver, and the backlight are arranged in the following sequence from the direction of an observer: display panel, transparent/scattering switching element, louver, backlight. Since the transparent/scattering switching element is thereby disposed on the back side of the display panel, it is possible to reduce the discomfort caused by an image display that appears to be recessed into the device by an amount commensurate with the thickness of the transparent/scattering switching element, in comparison to an arrangement in which the transparent/scattering switching element is disposed in front of the display panel.

The terminal device according to the present invention comprises the display device. The present invention has effects whereby moiré stripes are reduced while high transmittance is maintained, and surreptitious viewing is prevented. The present invention can therefore be suitably applied to a terminal device for handling important information.

A direction in which the light-direction regulating element regulates light rays is preferably parallel to a straight line connecting both eyes of an observer, or is preferably at an angle of 10 degrees or less in relation to a straight line connecting both eyes of an observer. This configuration makes it possible to prevent surreptitious viewing by a third party who is positioned on the left or right side of the observer.

The terminal device may be a mobile telephone, a personal information terminal, a gaming device, a digital camera, a video camera, a video player, a notebook personal computer, a cash dispenser, or a vending machine.

According to the present invention, moiré stripes formed by light passing through the optical element can be reduced, and high transmittance or high luminance can be maintained in an optical element formed by stacking together a light-direction regulating element in which transparent regions and non-transparent regions are periodically arranged in alternating fashion in a plane in one or two dimensions, and a two-dimensional lattice sheet in which transparent regions and non-transparent regions are periodically arranged in alternating fashion in two dimensions. The display device that incorporates the optical element of the present invention therefore has excellent display quality and a low occurrence of moiré. The directivity of light can also be increased by the light-direction regulating element, and the display device therefore has the effect of preventing surreptitious viewing.

### BRIEF DESCRIPTION OF THE DRAWINGS

FIG. 1 is a schematic sectional view showing the conventional privacy enabling device disclosed in Japanese Patent Application Laid-Open No. 2003-131202;

FIG. 2 is a top view showing the placement of the directional optical filter in relation to the display surface of the display device disclosed in Japanese Patent Application Laid-Open No. 60-15970;

FIG. 3 is a schematic perspective view showing the conventional display device provided with a directional optical filter for prevention of surreptitious viewing disclosed in Japanese Patent Application Laid-Open No. 60-159702;

FIG. 4 is a schematic structural diagram showing a conventional raster display device provided with a light control film disclosed in Japanese Patent No. 2622762;

FIG. 5 is a top view showing the positioning of the light control film with respect to the display surface of the display device;

FIG. 6 is a graph showing the relationship between the pitch p of the moiré stripes, and the angle β between the raster of the display device and the stripes of the light control film;

FIG. 7 is a schematic sectional view showing the conventional viewing-angle-controlled liquid crystal display device described in Japanese Patent Application Laid-Open No. 9-244018;

FIG. 8 is a schematic perspective view showing the illumination device used in the conventional viewing-angle-controlled liquid crystal display device described in Japanese Patent Application Laid-Open No. 9-244018;

FIG. 9 is a schematic perspective view showing the conventional viewing-angle-controlled liquid crystal display device described in Japanese Patent Application Laid-Open No. 9-244018;

FIG. 10 is a schematic top view showing the conventionally utilized pixel structure having four colors of sub-pixels;

FIG. 11A is a schematic plan view showing the light-direction regulating element; FIG. 11B is a schematic plan view showing the two-dimensional lattice sheet, wherein the two-dimensional lattice is shown in real space in the xy plane; FIG. 11C is a schematic plan view showing the two-dimensional lattice sheet, wherein the two-dimensional lattice is shown in real space in the xy plane; FIG. 11D is a diagram showing the inverse lattice in wavenumber space that corresponds to the one-dimensional lattice shown in FIG. 11A; FIG. 11E is a diagram showing the inverse lattice in wavenumber space that corresponds to the two-dimensional lattice shown in FIG. 11B; and FIG. 11F is a diagram showing the inverse lattice in wavenumber space that corresponds to the two-dimensional lattice shown in FIG. 11C;

FIG. 12A is a plan view that corresponds to a case in which the light-direction regulating element in FIG. 11A is superposed on the two-dimensional lattice sheet in FIG. 11B; and FIG. 12B is a diagram showing the arrangement in FIG. 12A in wavenumber space;

FIG. 13A is a plan view that corresponds to a case in which the light-direction regulating element in FIG. 11A is superposed on the two-dimensional lattice sheet in FIG. 11C; and FIG. 13B is a diagram showing the arrangement in FIG. 13A in wavenumber space;

FIG. 14A is a diagram of a case in which the angle formed by the wavenumber vectors fₓ and f_{y} in FIG. 13B is less than 90 degrees; and FIG. 14B is a diagram of a case in which the angle formed by the wavenumber vectors fₓ and f_{y} in FIG. 12B is less than 90 degrees;

FIG. 15 is a perspective view showing the relationship between the two-dimensional lattice vectors and the vantage point when the optical element is observed from a tilted direction;

FIG. 16 is a schematic view in which θ=0 degrees, and the x axis is observed from a vantage point at point-ahead angle φ;

FIG. 17 is a diagram showing the dependence of the wavenumber vector on the point-ahead angle φ in FIG. 13B;

FIG. 18 is a diagram showing the dependence of the wavenumber vector on the point-ahead angle φ in FIG. 12B;

FIG. 19 is a schematic plan view showing the pixel structure of the liquid crystal display element in a seventh embodiment of the present invention;

FIG. 20 is a schematic plan view showing the comb-shaped electrodes provided to the open parts of a pixel;

FIG. 21 is a perspective view showing the display device according to a third embodiment of the present invention;

FIG. 22 is a top view showing the louver used in the third embodiment;

FIG. 23 is a top view showing the positional relationship between the louver and a pixel in the third embodiment;

FIG. 24 is a perspective view showing the display device according to a fourth embodiment of the present invention;

FIG. 25 is a top view showing the pixel arrangement of the display panel, and the louver that is the light-direction regulating element used in the display device according to a fifth embodiment of the present invention;

FIG. 26 is a top view showing the pixel structure in the in-plane switching liquid crystal display device according to a sixth embodiment of the present invention;

FIG. 27 is a top view showing the pixel arrangement in the display device according to an eighth embodiment of the present invention;

FIG. 28 is a sectional view showing the transparent/scattering switching element used in a ninth embodiment of the present invention;

FIG. 29 is a perspective view showing the display device according to the ninth embodiment of the present invention;

FIG. 30 is a perspective view showing a mobile telephone in which the display device of the present invention is mounted;

FIG. 31 is a top view showing a pixel arranged in the display panel of a tenth embodiment of the present invention;

FIG. 32 is a top view showing a pixel of the display device according to a first modified example of the tenth embodiment of the present invention;

FIG. 33 is a perspective view showing the three-dimensional image display device according to a second modified example of the tenth embodiment of the present invention; and

FIG. 34 is an optical model diagram showing a cross section of the three-dimensional image display device along line A-A in FIG. 33.

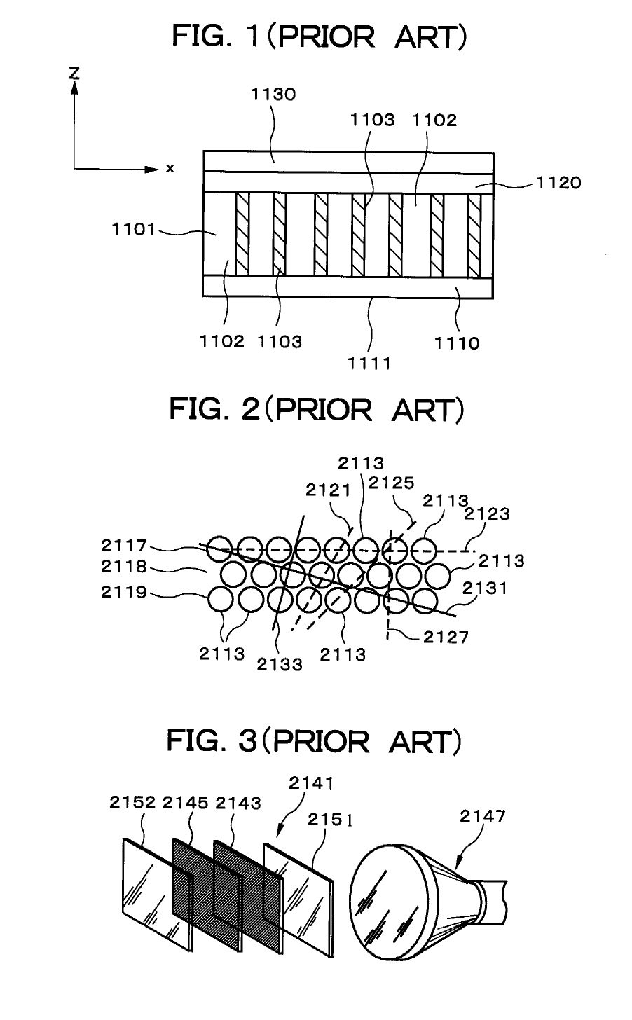

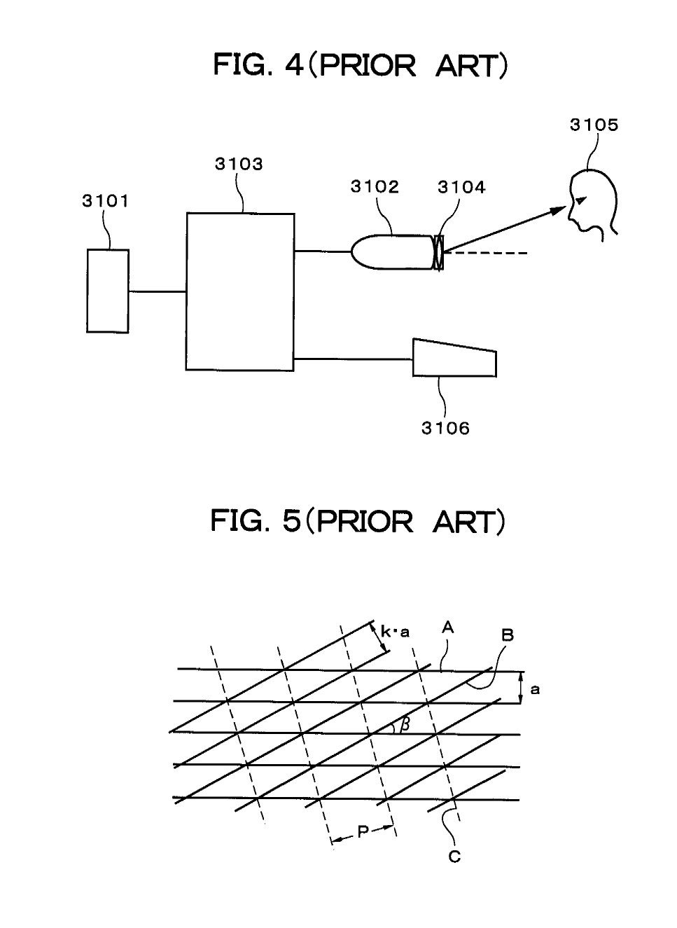

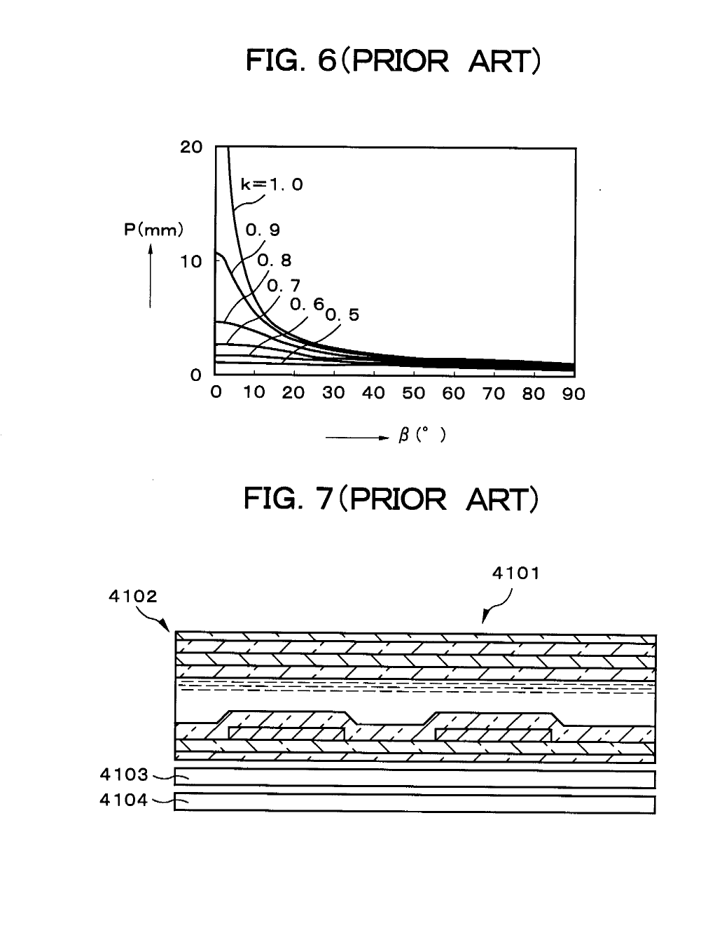

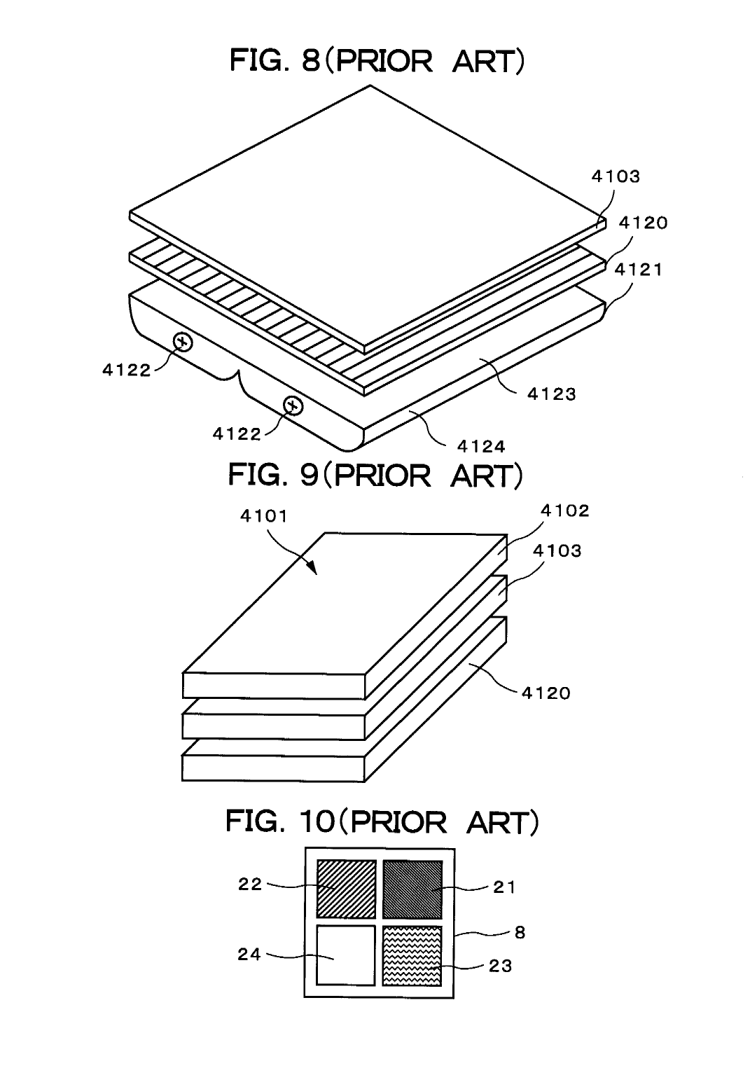

### DESCRIPTION OF THE PREFERRED EMBODIMENTS

The optical element, display device, and terminal device according to embodiments of the present invention will be described in detail with reference to the accompanying drawings. The optical element according to a first embodiment of the present invention will first be described in detail based on the operating principle thereof.

The optical element according to the first embodiment of the present invention is formed by stacking together a light-direction regulating element in which transparent regions and non-transparent regions are periodically arranged in alternating fashion in a plane in one dimension, and a two-dimensional lattice sheet in which transparent regions and non-transparent regions are periodically arranged in alternating fashion in two dimensions. The light-direction regulating element has one-dimensional translational symmetry due to the one-dimensional periodic structure thereof, and the two-dimensional lattice sheet has two-dimensional translational symmetry due to the two-dimensional lattice structure thereof. Translational movement that preserves the translational symmetry is generated by an arbitrary linear combination of primitive translational vectors. Specifically, the primitive translational vectors are periodic elementary units composed of vectors that link adjacent lattice points, and are linearly independent of each other. A characteristic feature in the optical element according to the first embodiment of the present invention is the manner in which the light-direction regulating element and the two-dimensional lattice sheet are layered together. The two primitive translation vectors in the two-dimensional lattice each have different sizes, and the angle between the primitive translation vector in the light-direction regulating element and the larger of the two primitive translation vectors in the two-dimensional lattice is equal to one-half or less of the angle between the two primitive translation vectors in the two-dimensional lattice. In other words, a characteristic feature of the optical element is that the projection component of the primitive translation vector of the light-direction regulating element onto the larger of the two primitive translation vectors in the two-dimensional lattice is larger than the projection component onto the smaller of the two primitive translation vectors.

The two-dimensional lattice sheet is a display panel, for example. The display panel has a plurality of pixels periodically arranged in two dimensions within the display plane, and light is blocked in the portion other than the open part of each pixel. The typical structure of the pixels can therefore be treated as a two-dimensional lattice. The light-direction regulating element is, e.g., a louver in which a transparent material and a non-transparent material are periodically arranged in one dimension in the form of a sheet, and the thickness of the sheet is measured in the direction perpendicular to the display plane.

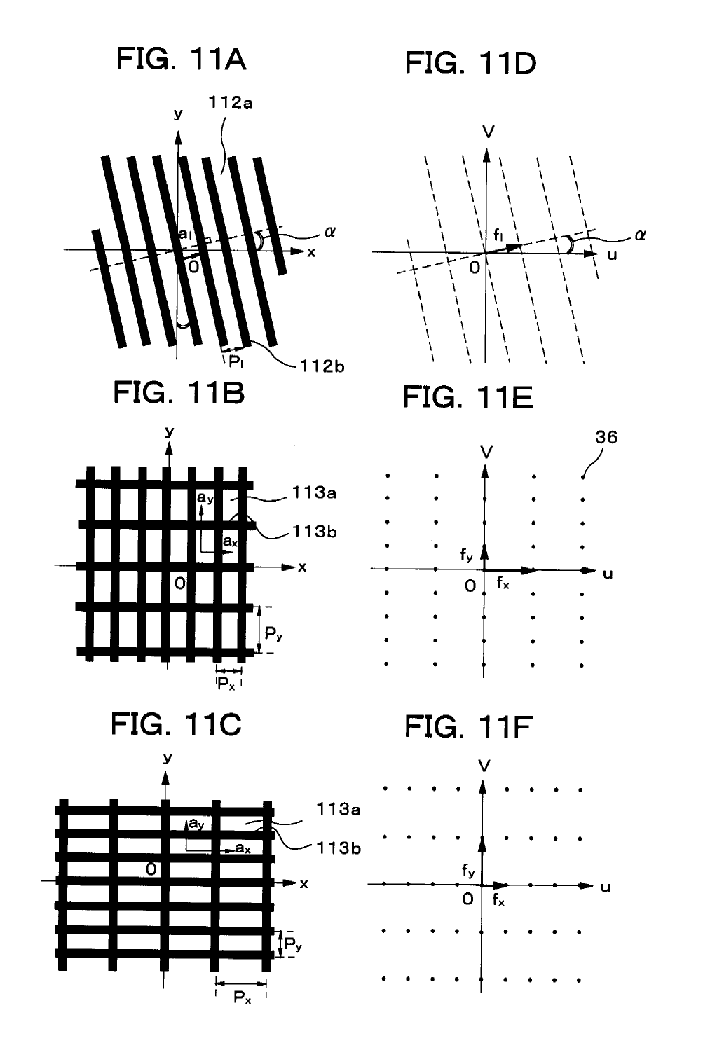

The structure, operation, and effect of the present embodiment will be described in detail hereinafter by comparison with a structure that differs from that of the present embodiment. FIG. 11A is a schematic plan view showing the light-direction regulating element, wherein the one-dimensional lattice is shown in real space in the xy plane. As shown in FIG. 11A, the light-direction regulating element is composed of a plurality of transparent regions 112a and non-transparent regions 112b extending in bands that are arranged parallel to each other in alternating fashion, wherein a one-dimensional periodic structure or a one-dimensional lattice is formed, and the period direction is at an angle α in relation to the positive x axis direction. This one-dimensional lattice (also referred to hereinafter as a striped pattern) can be expressed by the translational vector T₁ shown in Eq. 2 below.

\vec{T}₁=n\vec{a}₁ Eq.2

In Eq. 2, n is an arbitrary integer, and vector a₁ is a primitive translational vector (hereinafter referred to as primitive translational vector a₁) that corresponds to the one-dimensional period. Primitive translational vector a₁ is rotated at an angle α from the positive x axis direction. The size of primitive translational vector a₁ will be indicated as P₁ hereinafter. P₁ is the sum of the widths of a transparent region and a non-transparent region. Vectors are indicated without arrows in the text of the present specification, e.g., as “vector a₁,” but an arrow is added to “a₁” in the equations.

FIG. 11B is a schematic plan view showing the two-dimensional lattice sheet, wherein the two-dimensional lattice is shown in real space in the xy plane. As shown in FIG. 11B, non-transparent regions 113b are arranged in a two-dimensional lattice in the two-dimensional lattice sheet, the regions enclosed by the non-transparent regions are transparent regions 113a, and the transparent regions and non-transparent regions are periodically arranged in two dimensions. This two-dimensional lattice features two different-sized primitive translation vectors a₁, a_{y} that are orthogonal to each other. In FIG. 11B, Pₓ<P_{y}, wherein Pₓ and P_{y} are the sizes of primitive translation vectors aₓ, a_{y}, respectively. The two-dimensional lattice can be expressed by translation vector T₂ shown in Eq. 3 below using primitive translation vectors aₓ, a_{y}.

\vec{T}₂=l\vec{a}ₓ+m\vec{a}_{y} Eq. 3

In Eq. 3, 1 and m are arbitrary integers; primitive translation vector a₁ is the primitive translation vector in the x direction; and primitive translation vector a_{y} is the primitive translation vector in the y direction.

FIG. 11C is also a schematic plan view showing the two-dimensional lattice sheet, wherein the two-dimensional lattice is shown in real space in the xy plane. The difference with respect to FIG. 11B is that Pₓ>P₁, in FIG. 11C. Accordingly, the two-dimensional lattice is expressed by translation vector T₂ of Eq. 3. The light-direction regulating element corresponds to the light-blocking slitted sheet, and the two-dimensional lattice sheet corresponds to the liquid crystal display element in Japanese Patent Application Laid-Open No. 9-244018.

The inverse lattices in wavenumber space corresponding to the lattices of FIGS. 11A, 11B, and 11C will next be described. FIG. 11D is a diagram showing the inverse lattice in wavenumber space that corresponds to the one-dimensional lattice (striped pattern) shown in FIG. 11A, wherein the u axis and v axis in FIG. 11D are coordinate axes in wavenumber space that correspond to the x axis and the y axis in real space.

As shown in FIG. 11D, vector f₁ (hereinafter referred to as wavenumber vector f₁) forms an angle α in relation to the positive u axis direction, and is a vector in wavenumber space that corresponds to primitive translational vector a₁ in real space. The size of wavenumber vector f₁ is 1/P₁, and wavenumber vector f₁ can therefore be expressed by Eq. 4 below.

$${\vec{f}}_{1} = \frac{1}{{P}_{1}} ( cos ( α ) , sin ( α ) ) \qquad Eq . 4$$

Accordingly, translational vector K₁ in wavenumber space that corresponds to the one-dimensional lattice shown in FIG. 11A can be expressed by Eq. 5 below.

\vec{K}₁=n\vec{f}₁ Eq. 5

In Eq. 5, n is an arbitrary integer.

The inverse lattice that corresponds to the two-dimensional lattice shown in FIGS. 11B and 11C will next be described. FIGS. 11E and 11F are diagrams showing the inverse lattices in wavenumber space that correspond to the two-dimensional lattices shown in FIGS. 11B and 11C, respectively. Vectors fₓ, f_{y} (hereinafter referred to as wavenumber vectors fₓ, f_{y}) in wavenumber space that correspond to primitive translation vectors aₓ, a_{y} of the two-dimensional lattice can be expressed by Eq. 6 below.

$${\vec{f}}_{x} = \frac{1}{{P}_{x}} ( 1 , 0 ) , {\vec{f}}_{y} = \frac{1}{{P}_{y}} ( 0 , 1 ) \qquad Eq . 6$$

Specifically, wavenumber vector f₁ is a vector of size 1/Pₓ in the u axis direction, and wavenumber vector f_{y} is a vector of size 1/P_{y} in the v axis direction. Accordingly, translational vector K₂ in wavenumber space that corresponds to the two-dimensional lattice shown in FIGS. 11B and 11C can be expressed by Eq. 7 below.

\vec{K}₂=l\vec{f}ₓ+m\vec{f}_{y} Eq. 7

In Eq. 7, since (1, m) are arbitrary integers, there are numerous lattice points 36 (hereinafter referred to as inverse lattice points) that correspond to (1, m) in wavenumber space.

A case will next be described in which the two-dimensional lattice sheet and the light-direction regulating element formed from the one-dimensional lattice (striped pattern) are layered together. Moiré stripes are formed by the interference of two geometries in the space in which planes having two periodic patterns are superposed on each other. In Japanese Patent Application Laid-Open No. 9-244018, the extension direction of the light-blocking parts of the light-blocking slitted sheet coincides with the pixel arrangement direction of the liquid crystal display element. However, moiré stripes easily occur in such an arrangement. The light-blocking slits are therefore usually rotated at an angle α within the plane. However, since it is desirable for practicality that the viewing angle be controlled in the left-right direction of the screen, α is preferably 10 degrees or less. A case will therefore be described in which the tilt angle is set to angle α, and the angle α is 10 degrees or less. Because the moiré stripes also form a periodic pattern, the size of the moiré period will be referred to hereinafter as moiré period T.

The moiré period T when the light-direction regulating element and the two-dimensional lattice sheet are layered together is computed as described hereinafter. The vector f =(fᵤ, f_{y}) in wavenumber space of the moiré stripe can be expressed as the vector obtained by adding translational vectors K₁, K₂ of the one-dimensional and two-dimensional lattice in wavenumber space. Vector f will be referred to hereinafter as the moiré wavenumber vector. Accordingly, the moiré wavenumber vector f is expressed as shown in Eq. 8 below through the superposition of wavenumber vectors fₓ, f_{y} of the two-dimensional lattice and wavenumber vector f₁ of the one-dimensional lattice by Eqs. 5 and 6.

\vec{f}=(fᵤ,fᵥ)=l\vec{f}ₓ+m\vec{f}_{y}+n\vec{f}₁ Eq. 8

In Eq. 8, l, m, and n are arbitrary integers. The moiré period T is the inverse of the size |f| of the moiréwavenumber vector f, and is therefore expressed by Eq. 9 below.

T=1/\sqrt{fᵤ²+fᵥ²} Eq. 9

The angle β formed by the period direction of the moiréstripe and the positive u axis direction is calculated as shown in Eq. 10 below.

β=arctan(fᵥ/fᵤ) Eq. 10

The period and stripe direction of the generated moiréstripes can be computed as shown above. As shown in Eq. 8, the integers (l, m, n) are in arbitrary combinations in the moiré wavenumber vector, and numerous moiré periods are generated according to the combination of l, m, and n. The numerous moiré periods T arranged in order of size can be written as T1, T2, T3, and so on.

In practical terms, the moiré cannot be recognized by the eye when the moiré period T is adequately small, and therefore does not become a problem. However, when the moiré period T is large, moiré stripes are recognized by the human eye, and the display quality of the screen therefore decreases. Accordingly, whether the maximum moiré period T1 can be recognized is a significant practical problem. As shown in Eqs. 8 and 9, the moiré period T increases when l, m, and n are small. It is therefore apparent that adequate results can be obtained by taking into account instances in which l, m, and n are small.

Since the moiré period T is given by the inverse of the size |f| of the moiré wavenumber vector f (T=1/|f|), the combination (l, m, n) that yields the smallest value of |f| is the condition by which the moiré period T has the maximum size in real space. Particularly when the sizes of the layered lattices are about the same, and the rotation angle α is small, the size |f| of the moiré wavenumber vector f is minimized when the integers are in the combination of ±1, 0. Accordingly, the moiré period T is of maximum size when this condition occurs. The moiré stripe generated when (l, m, n)=(1, 0, −1) will therefore be described hereinafter for convenience. However, the description given below does not limit the combination of the integers, and other combinations are also possible.

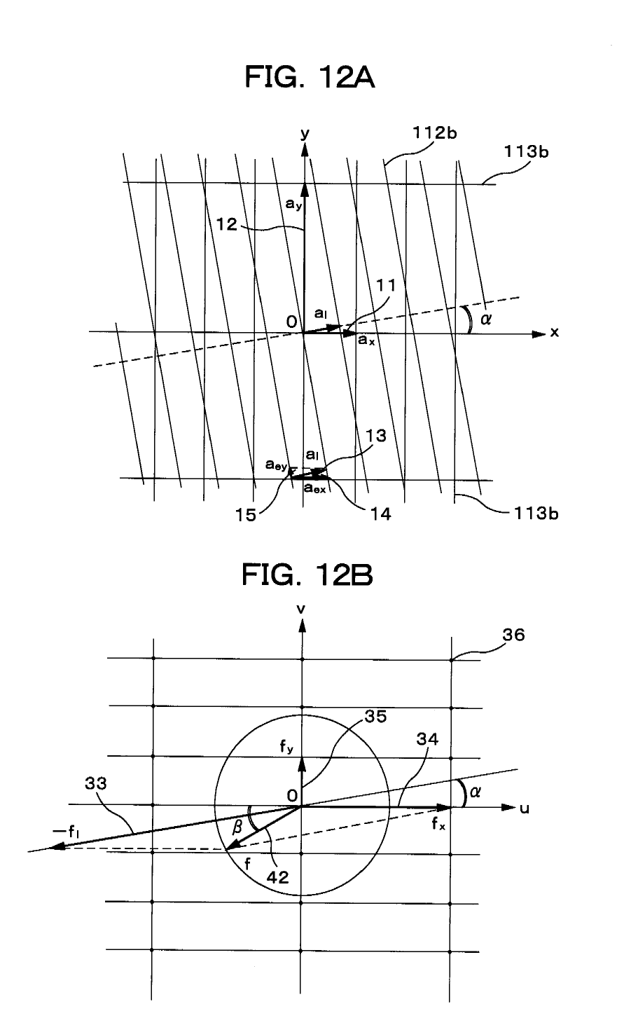

FIG. 12A is a plan view that corresponds to a case in which the light-direction regulating element in FIG. 11A is superposed on the two-dimensional lattice sheet in FIG. 11B. FIG. 12A shows the non-transparent regions 112b of the light-direction regulating element and the non-transparent regions 113b of the two-dimensional lattice sheet, and shows the relationship between the abovementioned primitive translational vector a₁ 13 of the one-dimensional lattice and the primitive translation vectors aₓ 11, a_{y} 12 of the two-dimensional lattice. FIG. 12B is a diagram showing the arrangement in FIG. 12A in wavenumber space

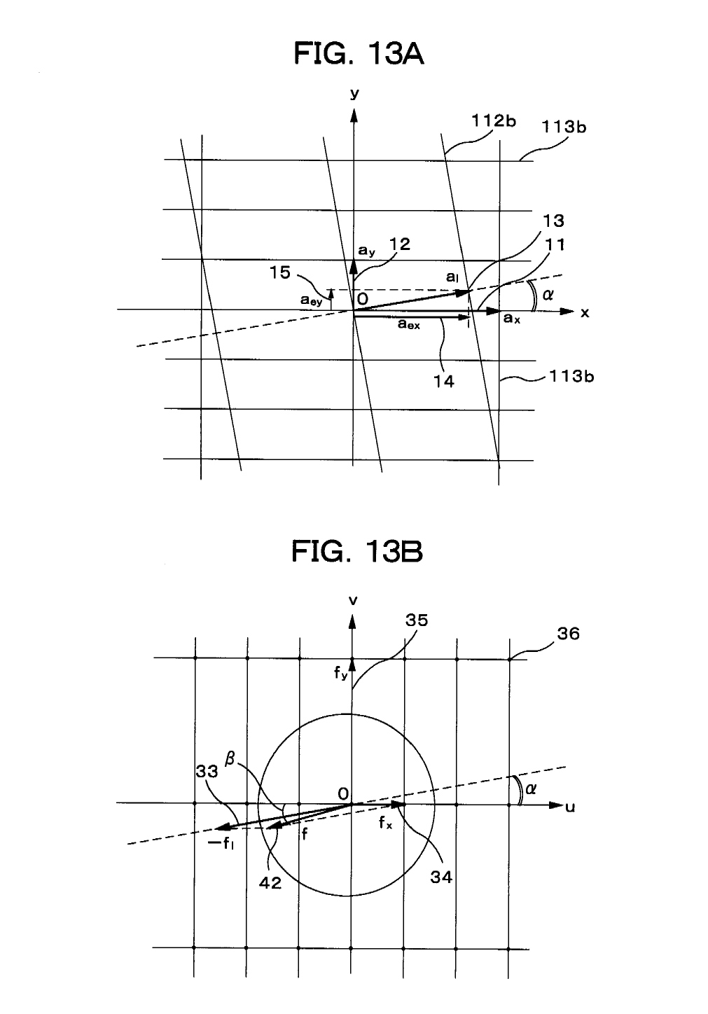

In the same manner, FIG. 13A is a plan view that corresponds to a case in which the light-direction regulating element in FIG. 11A is superposed on the two-dimensional lattice sheet in FIG. 11C; and FIG. 13B is a diagram showing the arrangement in FIG. 13A in wavenumber space. Therefore, the same reference symbols are used to indicate structural elements that are the same as in FIG. 12, and no detailed description thereof is given.

In the wavenumber space shown in FIGS. 12B and 13B, the horizontal axis is the coordinate axis u that corresponds to primitive translation vector aₓ; the vertical axis is the coordinate axis that corresponds to primitive translation vector a_{y}; and arbitrary combinations of the integers (1, m) are plotted as inverse lattice points 36 in wavenumber space. Vectors towards the inverse lattice points 36 from the origin represent translational vectors in the two-dimensional inverse lattice. Inverse lattice points 36 in the one-dimensional periodic arrangement pattern are also aligned on a straight line that is tilted at an angle α (approximately 10 degrees) in relation to the positive u axis direction, and vectors from the origin to the inverse lattice points represent translational vectors in the one-dimensional period direction.

The two-dimensional lattice of FIG. 12 in which P_{y}>Pₓ will next be compared with the two-dimensional lattice of FIG. 13 in which Pₓ>P_{y} Since conditions are compared in which same-sized moiré periods T=1/|f| are generated, circles having the radius |f| are shown simultaneously in FIGS. 12B and 13B.

In FIG. 12B, the interval of inverse lattice points in the u direction is larger than the interval of inverse lattice points in the v direction. As described above, the wavenumber vector f 42, computed as the sum of wavenumber vector fₓ 34 and wavenumber vector −f₁ 33, may be computed in order to compute the maximum value of the moiré period T, and there is therefore no need to consider wavenumber vector f_{y} 35. As a result, it is apparent that the size |f₁| of wavenumber vector −f₁ 33 must be large in order for wavenumber vector f 42 to be positioned on the circumference. This means that the size of the period of the one-dimensional periodic pattern in real space decreases with respect to the moiré period T.

In FIG. 13B, the interval of inverse lattice points in the u direction is smaller than the interval of inverse lattice points in the v direction. As a result, it is apparent that |f₁| can be made small in comparison to FIG. 12B. This means that the size of the period of the one-dimensional periodic pattern in real space is larger compared to the case of FIG. 12B with respect to the moiréperiod T. Accordingly, under conditions in which moiréhaving the same moiré period T is generated, the structure period of the one-dimensional lattice can be larger for a two-dimensional lattice in which P_{y}<Pₓ than for a two-dimensional lattice in which P_{y}>Pₓ.

A high transmittance is preferred in the light-direction regulating element used in the present invention, in which transparent regions and non-transparent regions are arranged in alternating fashion. For reasons relating to manufacturing, the width of the non-transparent regions has a lower limit. Consequently, the transmittance can be enhanced when the arrangement period of the light-direction regulating element is large. It is therefore apparent from comparison of FIG. 12B and FIG. 13B that because |f1| can be made smaller in FIG. 13B, the non-transparent regions account for a small ratio per unit area, and the light-direction regulating element has high transmittance. The optical element of the present embodiment has the structure shown in FIG. 13.

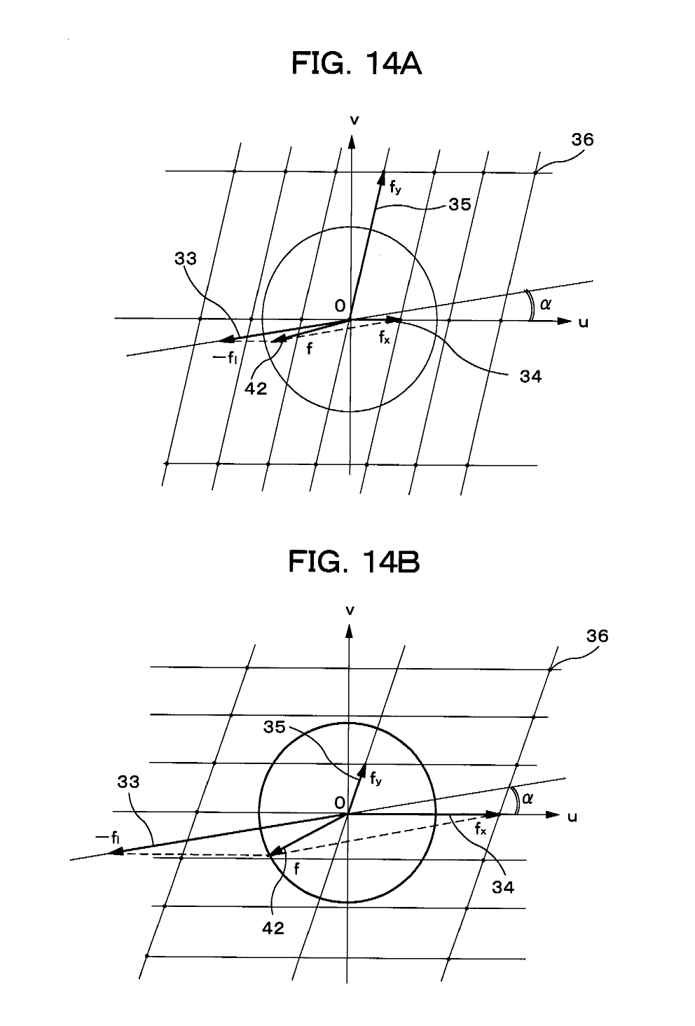

A case was described in which the two-dimensional lattice was an orthogonal lattice in FIG. 13, but the same conclusion is also drawn when the two-dimensional lattice is a non-orthogonal, orthorhombic lattice. A case is therefore considered in which the wavenumber vectors fₓ, f_{y} are not orthogonal. FIG. 14A is a diagram of a case in which the angle formed by the wavenumber vectors fₓ and f_{y} in FIG. 13B is less than 90 degrees; and FIG. 14B is a diagram of a case in which the angle formed by the wavenumber vectors fₓ and f_{y} in FIG. 12B is less than 90 degrees. Therefore, the same reference symbols are used to indicate structural elements that are the same as in FIGS. 13B and 12B, and no detailed description thereof is given. Since the direction of wavenumber vector fₓ is set to the positive u axis direction in FIG. 14A, the moiré wavenumber vector f does not include a component of wavenumber vector f_{y} the same as in FIG. 13B. Since the direction of wavenumber vector fₓ is also set to the positive u axis direction in FIG. 14B, the moiréwavenumber vector f does not include a component of wavenumber vector f_{y}, the same as in FIG. 12B. Therefore, even under conditions in which the primitive translation vectors aₓ, a_{y} are not orthogonal to each other, primitive translation vector aₓ is dominant with respect to the size of moiré period T when the angle range of α is small, and the same argument can therefore be made as when the primitive translation vectors aₓ, a_{y} are orthogonal to each other. Wavenumber vector f₁ of FIG. 14A can therefore also be set so as to be smaller than wavenumber vector f₁ of FIG. 14B in the orthorhombic lattice. As a result, the same high transmittance can be obtained in the configuration shown in FIG. 14A.

Following is a comparison of the components obtained when primitive translational vector a₁ of the one-dimensional lattice is projected onto each of the two primitive translation vectors aₓ, a_{y} of the two-dimensional lattice. As shown in FIG. 13A, the projection component aₑₓ of primitive translational vector a₁ in the direction of primitive translation vector aₓ is larger than the projection component a_{ey} of primitive translational vector a₁ in the direction of primitive translation vector a_{y}. Specifically, a characteristic feature regarding the vector sizes is that the projection component aₑₓ onto the larger vector (primitive translation vector aₓ) is larger than the projection component a_{ey} onto the smaller vector (primitive translation vector a_{y}). This means that the angle formed by primitive translational vector a₁ and primitive translation vector aₓ is 45 degrees or less. On the other hand, as shown in FIG. 12A, the projection component aₑₓ of primitive translational vector a₁ in the direction of primitive translation vector aₓ is smaller than the projection component a_{ey} of primitive translational vector a₁ in the direction of primitive translation vector a_{y}. The same characteristic also occurs in the case of an orthorhombic lattice. In the real space that corresponds to FIG. 14A, the projection component aₑₓ of primitive translational vector a₁ in the direction of primitive translation vector aₓ is larger than the projection component a_{ey} of primitive translational vector a₁ in the direction of primitive translation vector a_{y}. This means that the angle formed by primitive translational vector a₁ and primitive translation vector aₓ is one-half or less of the angle formed by primitive translation vector aₓ and primitive translation vector a_{y}. The angle α is preferably 10 degrees or less, but when α is one-half or less of the angle formed by aₓ and a_{y} (e.g., 45 degrees or less when aₓ and a_{y} are orthogonal), transmittance-enhancing effects such as those described above occur in the configuration shown in FIG. 13.

It is apparent from the above description that moirécan be reduced, and high transmittance can be obtained by using the optical element according to the present embodiment.

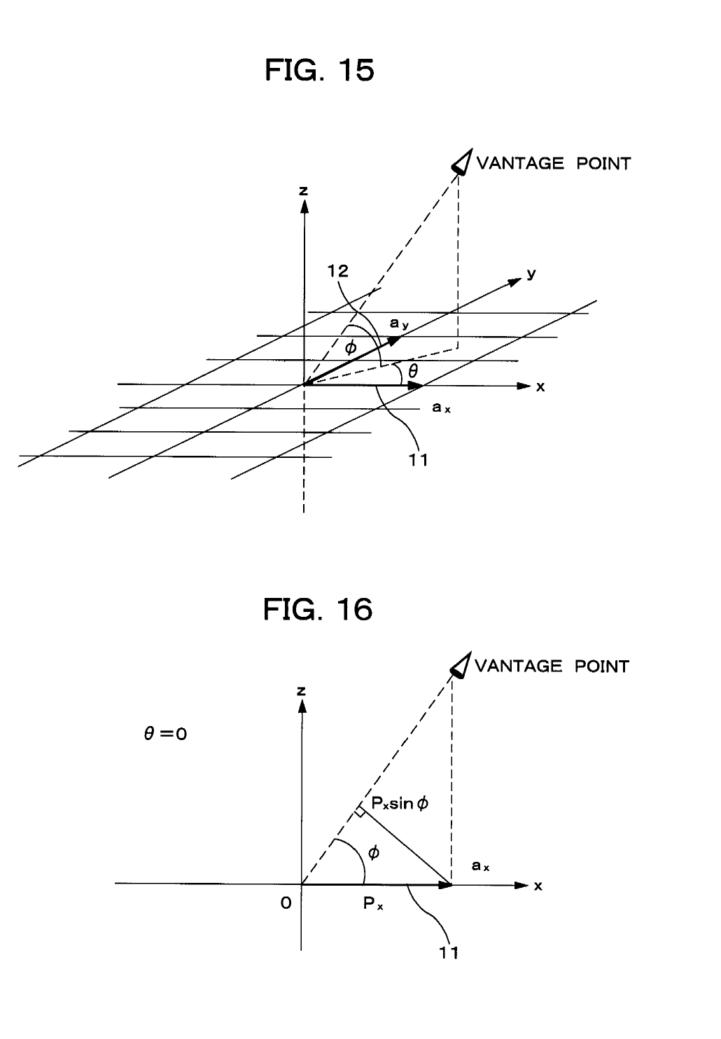

A case will next be described in which the optical element of the present embodiment is observed from a tilted direction rather than only from the front. The effects whereby the viewing-angle dependency of moiré period T is reduced will also be described. FIG. 15 is a perspective view showing the relationship between the two-dimensional lattice vectors and the vantage point when the optical element is observed from a tilted direction. The coordinate system is set up as described below for convenience. As shown in FIG. 15, the direction perpendicular to the two-dimensional plane (xy plane) formed by primitive translation vectors aₓ, a_{y} of the two-dimensional lattice is the z direction, the direction towards the observer is the +z direction, and the direction opposite the +z direction is the −z direction. The point where a vertical line that extends from the vantage point perpendicular to the xy plane intersects with the xy plane is point P, and the angle formed by the x axis and a straight line connecting the origin and point P is θ. Primitive translation vector aₓ is a vector on the x axis, and primitive translation vector a_{y} is a vector on the y axis. The angle formed by the straight line connecting the origin and point P, and a straight line connecting the origin and the vantage point is φ. Hereinafter, φ is referred to as the point-ahead angle.

FIG. 16 is a schematic view in which θ=0 degrees, and the x axis is observed from a vantage point at point-ahead angle φ. As shown in FIG. 16, the period in the apparent x direction decreases in size in proportion to sin φ. In the same manner, since the component in the x direction has a significant effect in the range in which angle θ is small in the one-dimensional period in the direction rotated at angle θ from the x axis, the size of the apparent P₁ decreases.

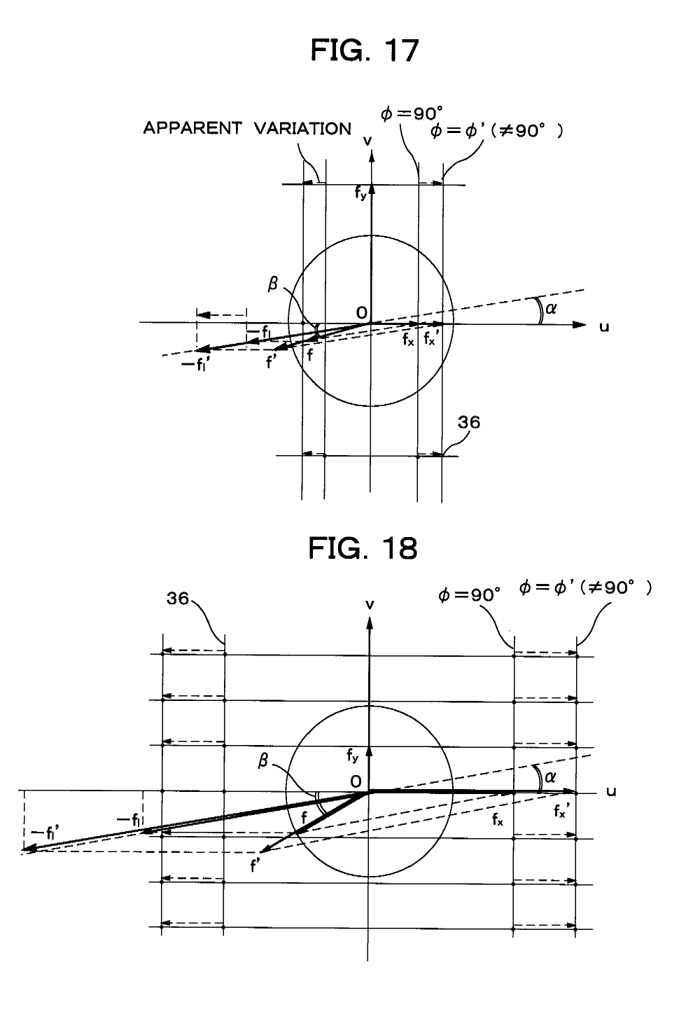

Since the apparent structural period thus decreases in size, the absolute value of the component in the u axis direction of the vector increases in the corresponding wavenumber space. FIG. 17 is a diagram showing the dependence of the wavenumber vector on the point-ahead angle φ in the configuration shown in FIG. 13B; and FIG. 18 is a diagram showing the dependence of the wavenumber vector on the point-ahead angle φ in the configuration shown in FIG. 12B. As previously mentioned, FIG. 17 corresponds to the configuration of the present embodiment. As shown in FIGS. 17 and 18, the inverse lattice points are shifted in the positive u axis direction in the range in which n>0, and are shifted in the negative u axis direction in the range in which n<0 when the point-ahead angle φ changes from 90 degrees to a value φ′ less than 90 degrees. Therefore, wavenumber vector fₓ of the two-dimensional lattice and wavenumber vector f₁ of the one-dimensional lattice change to wavenumber vector fₓ′ and wavenumber vector f₁′, respectively; the sizes thereof increase; and the size |f| of the moiré wavenumber vector f that corresponds to moiréperiod T increases (wavenumber vector f changes to wavenumber vector f′). At this time, the amount of displacement of the size |f| of the moiré wavenumber vector f is not only dependent on the point-ahead angle φ, but also on the sizes of wavenumber vectors f₁, fₓ. Since the amount of displacement is proportional to the sizes of wavenumber vectors f₁, fₓ, the amount of displacement in relation to the point-ahead angle φ decreases when the size decreases. Accordingly, the amount of displacement of the moiré wavenumber vector f is smaller in FIG. 17, in which f₁ and fₓ are small, than in FIG. 18.

Furthermore, regarding the angle β (<90 degrees) formed by the u axis and the moiré wavenumber vector f, it is apparent from FIGS. 17 and 18 that angle β in FIG. 17 can be made smaller than angle β in FIG. 18. Therefore, in addition to the fact that wavenumber vectors f₁, fₓ are smaller in FIG. 17 than in FIG. 18, since angle β is small, there is an extremely small amount of displacement in comparison to FIG. 18 of the size |f| of the moiréwavenumber vector f, which is obtained by adding wavenumber vectors f₁, fₓ. Specifically, in the case of FIG. 18, even when moiré cannot be identified from the front, moiré is highly likely to occur when viewed from a tilted direction. In the case of FIG. 17, the vector change corresponding to moiré is small even when the point-ahead angle φ is changed, and the likelihood of moiré formation is low. Consequently, when the display screen is viewed from the right-left direction, the viewing-angle dependency of moiré period T is reduced, and a high-quality display is therefore obtained.

The effects whereby the viewing-angle dependency of moiré period T is reduced may also be applied in an orthorhombic lattice in which aₓ and a_{y} are not orthogonal. It is sufficient insofar as the sizes Pₓ and P_{y} of primitive translation vectors aₓ and a_{y} satisfy the relation Pₓ>P_{y}, the primitive translational vector a₁ of the one-dimensional period pattern is projected in the direction of aₓ and a_{y}, and the projection component onto aₓ is large. The angle α (rotation angle of the one-dimensional period) formed by aₓ and a₁ is preferably small, e.g., −10 degrees<α<10 degrees.

A second embodiment of the present invention will next be described. The optical element according to the second embodiment of the present invention is formed by stacking together a light-direction regulating element in which transparent regions and non-transparent regions are periodically arranged in alternating fashion in a plane in two dimensions, and a two-dimensional lattice sheet in which transparent regions and non-transparent regions are periodically arranged in alternating fashion in two dimensions. The light-direction regulating element has two-dimensional translational symmetry due to the two-dimensional periodic structure thereof, and the two-dimensional lattice sheet has two-dimensional translational symmetry due to the two-dimensional lattice structure thereof. Translational movement that preserves the translational symmetry is generated by an arbitrary linear combination of primitive translational vectors. A characteristic feature in the optical element according to the second embodiment of the present invention is the manner in which the light-direction regulating element and the two-dimensional lattice sheet are layered together. The two primitive translation vectors a₁, a₂ in the two-dimensional lattice sheet each have different sizes (size of primitive translational vector a₁>size of primitive translation vector a₂); the two primitive translation vectors b₁, b₂ in the light-direction regulating element each have different sizes (size of primitive translational vector b₁<size of primitive translation vector b₂); the projected component of primitive translational vector b₁ in the direction of primitive translational vector a₁ is larger than the projected component of primitive translational vector b₁ in the direction of primitive translation vector a₂; and the projected component of primitive translation vector b₂ in the direction of primitive translation vector a₂ is larger than the projected component of primitive translational vector b₁ in the direction of primitive translational vector a₁. This means that the angle formed by primitive translational vector b₁ and primitive translational vector a₁ is one-half or less of the angle formed by primitive translational vector a₁ and primitive translation vector a₂; and the angle formed by primitive translation vector b₂ and primitive translation vector a₂ is one-half or less of the angle formed by primitive translational vector a₁ and primitive translation vector a₂.

The relationship between primitive translational vector b₁ and primitive translational vectors a₁, a₂, and the relationship between primitive translation vector a₂ and primitive translational vectors b₁, b₂ are that of a two-dimensional lattice and a one-dimensional lattice, and the lattices have the same structure as in the first embodiment. Consequently, the same operations and effects are obtained as those of the first embodiment, and since a two-dimensional lattice and a two-dimensional lattice are layered together, the same effects are obtained in the vertical direction as in the direction to the left and right of the sight line.

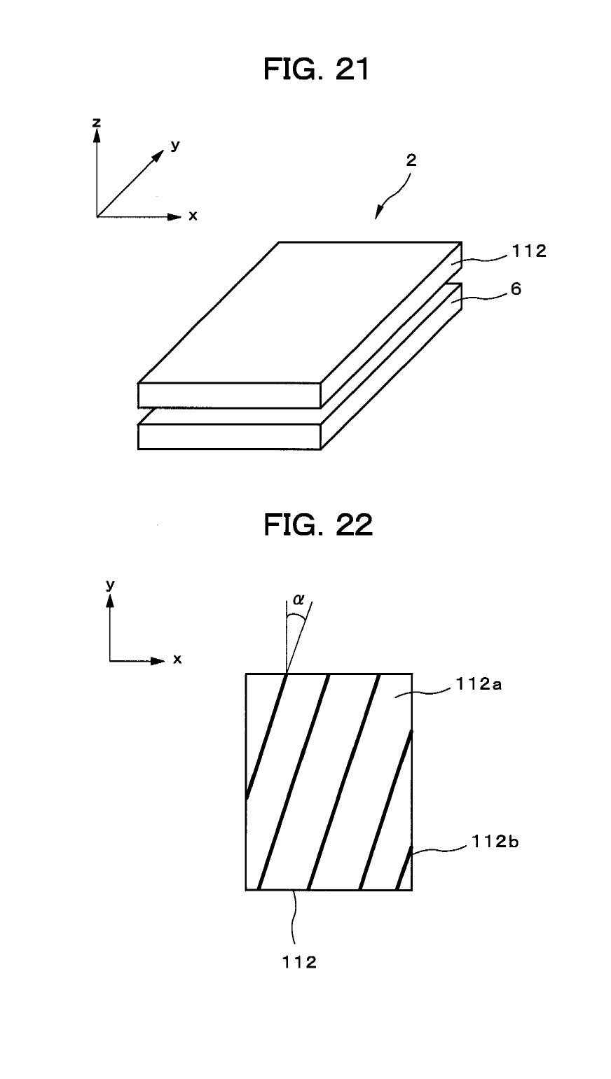

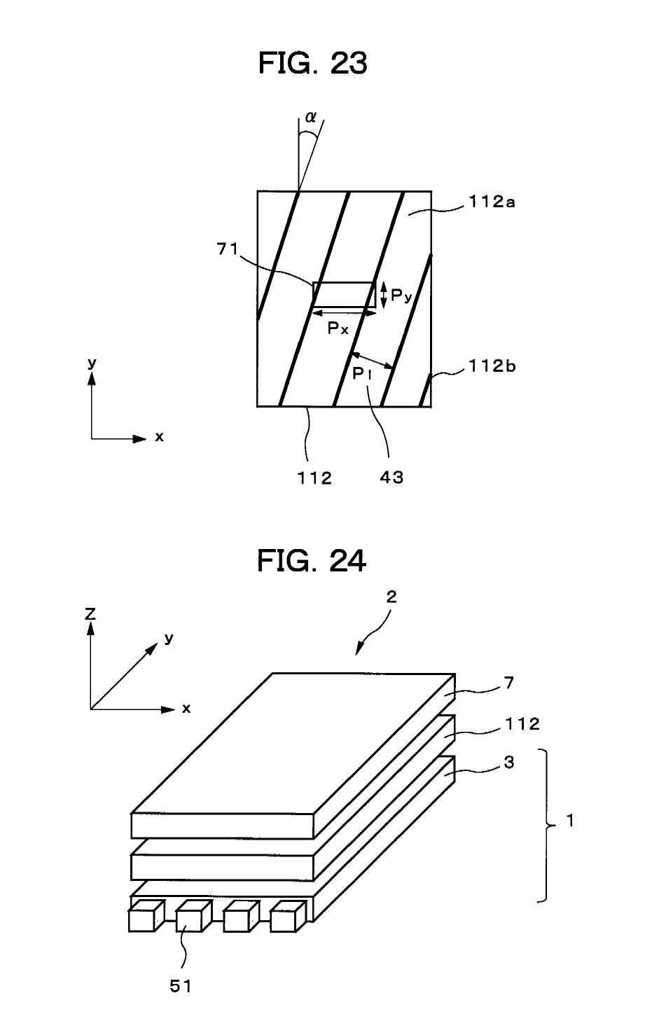

The display device according to a third embodiment of the present invention will next be described. FIG. 21 is a perspective view showing the display device according to the present embodiment; FIG. 22 is a top view showing the louver used in the present embodiment; and FIG. 23 is a top view showing the positional relationship between the louver and a pixel in the present embodiment.

As shown in FIG. 21, a self-luminous display panel 6 is provided, and a louver 112 that is a light-direction regulating element is provided on the self-luminous display panel 6 in the display device 2 of the present embodiment. The louver 112 is a sheet in which a transparent material and a non-transparent material are periodically arranged in one dimension, and the thickness of the louver is measured in the direction perpendicular to the display plane. An organic EL (Electroluminescence) panel, for example, may be applied as the self-luminous panel 6. The display panel 6 has a plurality of pixels periodically arranged in two-dimensions within the display plane, and a black matrix (not shown) for preventing light leakage and enhancing contrast is provided to each pixel. Except for the black matrix, there are no structures that block light from the light source. Therefore, when the display is viewed from above the display plane, a lattice formed by the black matrix is arranged in a matrix having numerous periods, whereby controlled light from the open parts in the black matrix can be emitted, and information can be displayed.

An xyz orthogonal coordinate system is set up as described below for convenience in the present embodiment. As shown in FIG. 21, the display panel 6 is rectangular, and the y axis is in the longitudinal direction of the display panel and is parallel to the display plane. The direction into the paper surface along the y axis is the +y direction, and the direction opposite the +y direction is the −y direction. The +y direction and the −y direction are collectively referred to as the y axis direction. The x axis is within the display plane and orthogonal to the y axis, the direction to the right on the paper surface is the +x direction, and the direction opposite the +x direction is the −x direction. The +x direction and the −x direction are collectively referred to as the x axis direction. Furthermore, the direction that is orthogonal to both the x axis direction and the y axis direction is the z axis direction; and within the z axis direction, the direction toward an observer positioned above the paper surface is the +z direction, and the direction opposite the +z direction is the −z direction. The coordinate system is a right-handed coordinate system, i.e., when the person's right thumb is in the +x direction, and the index finger is in the +y direction, the middle finger is in the +z direction.

As shown in FIG. 22, the louver 112 is formed by arranging a transparent regions 112a for transmitting light, and non-transparent regions 112b for absorbing light in alternating fashion in the direction of one dimension parallel to the surface of the louver 112. As shown in FIG. 22, the +x direction leads to the right on the paper surface, and the +y direction leads upward on the paper surface. In the present embodiment, the non-transparent regions 112b are layers that completely absorb light. The direction of the boundaries between the transparent regions 112a and the non-transparent regions 112b is set to a direction that is tilted clockwise at an angle α from the positive y axis direction in the xy plane. Specifically, the direction in which the transparent regions 112a and non-transparent regions 112b are arranged is tilted clockwise at an angle α from the positive x axis direction, and the arrangement pitch indicated by the sum of a transparent region 112a and a non-transparent region 112b is constant along the arrangement direction. In the present embodiment, the angle α may be set to 10 degrees, for example. The width of an absorbent region is 10 μm, and the width of a transparent region is 50 μm. The arrangement pitch that is the sum of the aforementioned widths is therefore set to 60 μm.

The positional relationship between the louver and the pixels of the display panel will next be described. FIG. 23 is a top view showing the positional relationship between the louver 112 and a pixel 71 as viewed from the light-exiting surface 43 of the louver 112. As shown in FIG. 23, the pixel 71 is rectangular, wherein the long edge is parallel to the x axis, and the short edge is parallel to the y axis. An xy coordinate system is set up in the same manner as in FIG. 22. By way of example in the present embodiment, the pixel pitch Pₓ in the x axis direction is 141 μm, the pixel pitch P_{y} in the y axis direction is 47 μm, and the structure period in the x direction is three times the structure period in the y direction.

Since the boundaries between the transparent regions 112a and the non-transparent regions 112b of the louver 112 are tilted 10 degrees clockwise in the +y direction in the xy plane, the direction in which the transparent regions 112a and the non-transparent regions 112b of the louver 112 are alternately arranged in periodic fashion is tilted 10 degrees clockwise in the +x direction. The arrangement pitch of the louver 112 along the period direction is designated as P₁. As shown in FIG. 23, the one-dimensional period direction of the louver 112 differs from the x axis direction and the y axis direction, which are the period directions of the two-dimensional arrangement of the pixels 71.

In the present embodiment, the pixel pitch Pₓ in the x axis direction is set so as to be larger than the pixel pitch P_{y} in the y axis direction. Therefore, the size aₑₓ obtained when primitive translational vector a₁, whose units are single periods in the direction of the one-dimensional periodic arrangement of the louver 112, is projected in the x axis direction is set so as to be larger than the size a_{ey} obtained when primitive translational vector a₁ is projected in the y axis direction. Accordingly, the positional relationship of the pixel and the louver in the present embodiment is the same as in the structure of the optical element of the first embodiment.

The operation of the present embodiment configured as described above will next be described using FIGS. 21 through 23. In the display state of the display device 2, light emitted from the self-luminous display panel 6 exits from the open parts of the pixels and enters the louver 112. The non-transparent regions 112b of the louver 112 absorb light rays entering the louver 112 that are significantly tilted towards the direction in which the transparent regions 112a and the non-transparent regions 112b are periodically arranged in alternating fashion, i.e., the light components that are significantly tilted towards the periodic arrangement direction of the louver 112 from the positive z axis direction. Light that passes through the transparent regions 112a without being absorbed by the non-transparent regions 112b of the louver 112 is emitted in an unchanged state. The light emitted from the louver 112 therefore has high directivity. The light emitted from the open parts of the pixels is endowed with a periodic distribution in the x axis direction and the y axis direction by the black matrix, and therefore interferes with the periodic structure of the transparent/non-transparent regions of the louver, and forms moiré stripes. However, moiré stripes are reduced by the structure of the present embodiment in the same manner as in the first embodiment.

The principle by which the moiré stripes are generated, and the method for computing the size of the period were described previously, but the method of computing the moiréperiod T will be further described. The moiré period T can be computed by adding together the wavenumber vectors of the moiré in wavenumber space using the pixel pitch (Pₓ, P_{y}), the louver pitch P₁, and the louver tilt angle α. The pixels 71 form a two-dimensional arrangement of numerous pixels in a matrix, whereas the louver 112 has a structure in which transparent regions 112a and non-transparent regions 112b are arranged in one dimension. Accordingly, the periodicity of the louver 112 and the periodicity in the x direction and y direction of the pixels 71 can be indicated as shown in Eq. 11 below in wavenumber space.

$${\vec{f}}_{x} = \frac{1}{{P}_{x}} ( 1 , 0 ) , {\vec{f}}_{y} = \frac{1}{{P}_{y}} ( 0 , 1 ) , {\vec{f}}_{l} = \frac{1}{{P}_{l}} ( cos ( α ) , sin ( α ) ) \qquad Eq . 11$$

In Eq. 11, wavenumber vectors fₓ and f_{y} correspond to primitive translation vectors in the x and y directions of each pixel 71; and wavenumber vector f₁ corresponds to a one-dimensional periodic primitive translation vector of the louver 112. The coordinate components are u and v coordinate components in wavenumber space. These wavenumber vectors are added according to Eq. 12 below, and the moiréperiod T can be computed using Eq. 13 below.

$$\begin{matrix}( {f}_{u} , {f}_{v} ) = l {\vec{f}}_{x} + m {\vec{f}}_{y} + n {\vec{f}}_{t} & Eq . 12 \\ T = \frac{1}{\sqrt{{f}_{u}^{2} + {f}_{v}^{2}}} & Eq . 13\end{matrix}$$

In Eq. 13, (l, m, n) are a group of arbitrary integers. The angle β of rotation of the moiré wavenumber vector from the u axis direction is calculated by Eq. 14 below.

β=arctan(fᵥ/fᵤ) Eq. 14

The configuration of the present embodiment is applied to these equations to compute the moiré period T. In the present embodiment, the P₁ of the louver 112 is 60 μm, the pixel pitch Pₓ is 141 μm, the pixel pitch P_{y} is 47 μm, and the louver rotation angle α is 10 degrees. The maximum value of the moiré period T is computed as 176 μm hereinafter.

The effect of the present embodiment will next be described. The present embodiment produces the same effects as the first embodiment. Since moiré is reduced, high transmittance and high luminance can be maintained. Light emitted from the display panel is also endowed with high directivity by the louver, and privacy-enabling effects are obtained.

A comparative example that differs from the present embodiment will be described in order to specifically describe the effect of the present embodiment. The case used for comparison is one in which the pixel pitch Pₓ is 47 μm, and the pixel pitch P_{y} is 141 μm. The ratio of Pₓ to P_{y} in this pixel is 1 to 3, and the area of the pixel is the same as that of the pixel of the present embodiment. Accordingly, in the pixel used for comparison (hereinafter referred to as the comparison pixel), the louver pitch P₁ is 60 μm, the pixel pitch Pₓ is 47 μm, P_{y} is 151 μm, and the louver tilt angle α is 10 degrees. When these values are substituted into the abovementioned equations, the maximum period of the moiré is calculated as 273 μm. The moiréperiod T in the present embodiment is therefore reduced to 64% of the moiré period in the comparison pixel.

The period of moiré stripes increases in size as the louver pitch is increased. In the present embodiment, however, the moiré period is about the same as in the comparison pixel even when the louver pitch is set to 100 μm. The ratio of transparent regions in the louver surface (hereinafter referred to as the open ratio) is 83% at a pitch of 60 μm, and 90% at a pitch of 100 μm. Since the open ratio can be increased, the moiré stripes can be reduced and high transmittance can be maintained.

As previously mentioned, the effects described below can be anticipated by increasing the pitch of the louver. The moiré period T usually changes as a result of varying the apparent pitch when the screen is viewed from a tilted direction within the viewing angle range, which results in viewing angle dependency and decreased image quality. In the present embodiment, variation of the moiré period T can be reduced, and display quality can be enhanced by enlarging the structure period in the transverse direction.

The pitch of the absorbent regions of the louver, the tilt angle of the louver, and the pixel pitch in the present embodiment are not limited by the numerical values mentioned above, and may be appropriately varied in ranges that produce the same effects.

A fourth embodiment of the present invention shall be described next. FIG. 24 is a perspective view showing a display device according to the present embodiment; and FIG. 22 is a top view showing a louver used in the present embodiment.

A light source device 1 is provided in a display device 2 according to the present embodiment, and a transmissive liquid crystal panel 7 is provided above the light source device 1, as shown in FIG. 24. The light source device 1 is composed of a light guide plate 3; a light source 51 provided to a side surface of the light guide plate 3; and a louver 112, which is a light-direction regulating element, disposed on a front surface side of the light guide plate 3, i.e., on the side of an observer in a +z direction. The light source 51 is, e.g., an LED (light emitting diode).

In the present embodiment, a xyz orthogonal coordinate system such as described below is used for the sake of simplicity. A direction extending from the light source 51 toward the light guide plate 3 is a +y direction; and the reverse direction is a −y direction. The +y direction and −y direction are collectively referred to as a y axis direction. A direction orthogonal to the y axis direction in a direction parallel to a light-emitting surface of the light guide plate 3, which is the surface on the louver side, is an x axis direction. A direction orthogonal to both the x axis direction and the y axis direction is a z axis direction. In the z axis direction, a direction extending from the light guide plate 3 toward the louver 112 is a +z direction, and the opposite direction is a −z direction. The +z direction faces forward, i.e., faces the observer. The coordinate system is a right-handed coordinate system in the +x direction, i.e., when the person's right thumb is in the +x direction, and the index finger is in the +y direction, a middle finger is in the +z direction.

The transmissive liquid crystal panel 7 is used to display information using light generated by the light source device 1 provided to a back surface of a liquid crystal panel as seen from the side of the observer. A plurality of pixels having transmissive display regions is arranged in a matrix pattern in the x direction and y direction. The transmissive liquid crystal panel of the present embodiment is a TN (twisted nematic). A structure that blocks light from the light source is absent from the pixels in areas that lie outside of a black matrix. A pixel structure of the present embodiment has the same configuration as the third embodiment and has a rectangular lattice form, as shown in FIG. 23. All parts are covered by the black matrix except for an open part of the pixels. The black matrix has a width of, e.g., 10 μm. The pixels 71 have an arrangement pitch of, e.g., 141 μm in the x direction and 47 μm in the y direction.

The louver of the present embodiment has the same configuration as the louver of the second embodiment. The louver 112 is formed so that, e.g., a transparent region 112a that transmits light, and an absorbing region 112b that absorbs light are disposed in alternating fashion in a direction parallel to a surface of the louver 112, as shown in FIG. 22.

An interface between the transparent region 112a and the non-transparent region 112b of the louver 112 is inclined 10 degrees clockwise from the +y direction of the y axis within a xy plane. Therefore, a periodic direction in which the transparent regions and non-transparent regions of the louver are arranged in alternating fashion is inclined 10 degrees in the clockwise direction from the +x direction of the x axis. Therefore, the periodic direction in which the transparent regions and non-transparent regions of the louver are arranged in alternating fashion, the x axis direction as a periodic direction of the pixel structure, and the y axis direction are mutually different directions. In the present embodiment, the pixel pitch is high in the x axis direction. Therefore, a single-period vector in the periodic arrangement direction of the transparent/non-transparent regions of the louver is larger when projected in the x axis direction of the pixels than when projected in the y axis direction of the pixels. The configuration is otherwise the same as the third embodiment.

An operation of the present embodiment shall be described next. Light emitted from the light source 51 is made incident on the light guide plate 3, is reflected after being transmitted by the light guide plate 3, and is emitted from a light emission surface, which is a surface on the side of the louver 112. The light emitted from the light guide plate 3 is diffused light that strikes the louver 112, whereby light spread in a light control direction is absorbed by the non-transparent regions 112b of the louver 112, and light emitted from the louver 112 is light having a high-directivity distribution. The dispersed light having high directivity is transmitted through the transmissive liquid crystal panel 7 and displayed. Light emitted from the open part of a pixel is endowed with a periodic distribution in the x axis direction and y axis direction by the black matrix. The light therefore interferes with the periodic structure of the transparent/non-transparent regions of the louver and generates moiré stripes. However, as in the first embodiment, the occurrence of moiré stripes is reduced by the configuration of the present embodiment.

Effects of the present embodiment shall be described next. The present embodiment produces the same effect as the third embodiment. In addition to reducing moiré, high transmissivity or high luminance can be maintained, light emitted from the display panel by the louver has high directivity, and a privacy-enabling effect is obtained. The display panel can be disposed at a position closest to the observer. Therefore, it is possible to reduce the discomfort caused by an image display that appears to be recessed into the device by an amount commensurate with the thickness of the member provided to the front surface of the display panel with respect to a top-most surface of the display device.

In the present embodiment, a configuration was described in which the transmissive liquid crystal panel and the louver were disposed sequentially as seen from the +z direction, i.e., the side of the observer. However, the order is not necessarily limiting, and the members may be disposed in a different arbitrary order within a range that has the same effect. In addition to the above-described order, examples of such arrangements include a configuration in which the louver and the transmissive liquid crystal panel are disposed sequentially. In particular, when the transmissive liquid crystal panel is disposed on the side of the observer, it is possible to reduce the discomfort caused by an image display that appears to be recessed into the device by an amount commensurate with the thickness of the member provided to the front surface of the display panel with respect to a top-most surface of the display device more than in other instances.

The display panel used in combination with the light source device of the present embodiment is not limited to a transmissive liquid crystal panel, and any display device can be used as long as the display panel uses a light source device. The liquid crystal panel is not limited to a transmission panel, and any liquid crystal panel can be used as long as the panel has a transparent region in the pixels. Transflective liquid crystal panels having a reflective region in some of the pixels, a micro-transmissive liquid crystal panel, or a micro-reflective liquid crystal panel may also be used.

The display device of the present invention can suitably be used in a mobile telephone or another mobile terminal device. As a mobile terminal device, the present invention is not limited to mobile telephones and can also be used in PDAs, gaming machines, digital cameras, digital video cameras, and a variety of other mobile terminal devices. The present invention is not limited to mobile terminal devices, and can also be used in notebook PCs, cash dispensers, vending machines, and a variety of other terminal devices.

The direction toward which the light beam is controlled by the light-direction regulating element preferably is parallel with a straight line connecting both eyes of a user, or is such that an angle of 10 degrees or less is formed with the straight line connecting both eyes of the user. When a terminal device is used in public spaces, the terminal device is often viewed by a third party positioned nearby. In other words, it is more effective in terms of security to prevent the display screen from being viewed from the lateral direction than to prevent the screen from being viewed in the vertical direction. Therefore, in order to prevent third parties positioned on both sides of the observer from viewing (the screen), the light-direction regulating element preferably controls the direction of the light beam to be parallel to a straight line connecting both eyes of the terminal user.

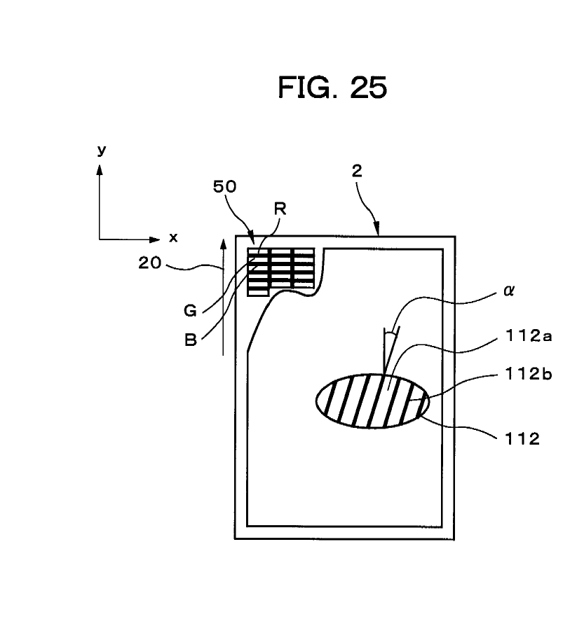

A display device according to a fifth embodiment of the present invention shall next be described. The display device according to the present embodiment is a liquid crystal display device comprising a transmissive liquid crystal display panel, wherein the liquid crystal display panel has a color filter. FIG. 25 is a top view showing a pixel arrangement of a display panel, and a louver that is a light-direction regulating element used in the display device according to the present embodiment.

In a display device 2 of the present embodiment, a color filter 50 is provided to a surface of the display panel that is on the side of an observer, which is a +z side, as shown in FIG. 25. Pixels of the display panel are composed of a plurality of sub-pixels divided in accordance with a number of a color scheme of the color filter. The sub-pixels have a rectangular shape. Long edges of the rectangles are parallel to the x axis, and short edges of the rectangles are parallel to the y axis. The xy coordinate system is established in the same manner as in FIG. 23, wherein the +z direction is above the page space perpendicular to the xy axis. The color filter 50 is arranged into a striped pattern. A periodic arrangement direction 20 of the stripes is a direction perpendicular to long edges of the lattice constituting the pixels, i.e., is the y direction. The color scheme of the present embodiment has the three colors of R (red), G (green), and B (blue), and is arranged in a sequence of RGB. Therefore, one pixel is divided into three sub-pixels. The sub-pixels are composed of an open part and a light-blocking part, and a typical configuration of the sub-pixels can be treated as a two-dimensional lattice. For this reason, the sub-pixels have translational symmetry similar to the pixels of the first through fourth embodiments. In particular, the sub-pixels have two primitive translation vectors that are parallel to the x axis and the y axis, respectively, and that have mutually different magnitudes. The vector that has the larger primitive translation vector is orthogonal to the periodic arrangement direction 20 of the stripes. The configuration is otherwise the same as the configuration of the fourth embodiment.

The periodic arrangement direction of the transparent regions 112a and non-transparent regions 112b of the louver 112 is inclined in the clockwise direction toward the positive direction of the x axis so that an angle α is 10 degrees. The periodic arrangement direction of the louver 112 forms a 100-degree angle with the periodic arrangement direction 20 of the stripes of the color filter 50. The RGB of the color filter 50 is arranged into one-dimensional stripes. On the other hand, the transparent regions 112a and non-transparent regions 112b of the louver 112 are also arranged one-dimensionally. Therefore, new moiré stripes (referred to below as “color moiré stripes”) are formed by these periodic structures, and the quality of the display decreases. However, the magnitude of the resulting color moiré stripes can be reduced to a level unnoticeable by the human eye as long as the periodic directions are between 80 and 100 degrees to one another. In particular, as long as the angle between the periodic direction of the louver 112 and the periodic direction of the stripe pattern of the color filter 50 is 90 degrees and the periodic directions are orthogonal to one another, the periodic directions will not interfere with one another, and color moiré stripes will therefore not be formed. As described above, in the present embodiment, the periodic arrangement direction of the louver 112 forms a 100-degree angle with the periodic arrangement direction 20 of the color filter 50 stripes, the periodic arrangement of the transparent regions 112 and non-transparent regions 112b of the louver 112 and the color stripes of the color filter 50 do not interfere with one another, a color display having minimal color moiré can be produced, and exceptional display quality can be realized.

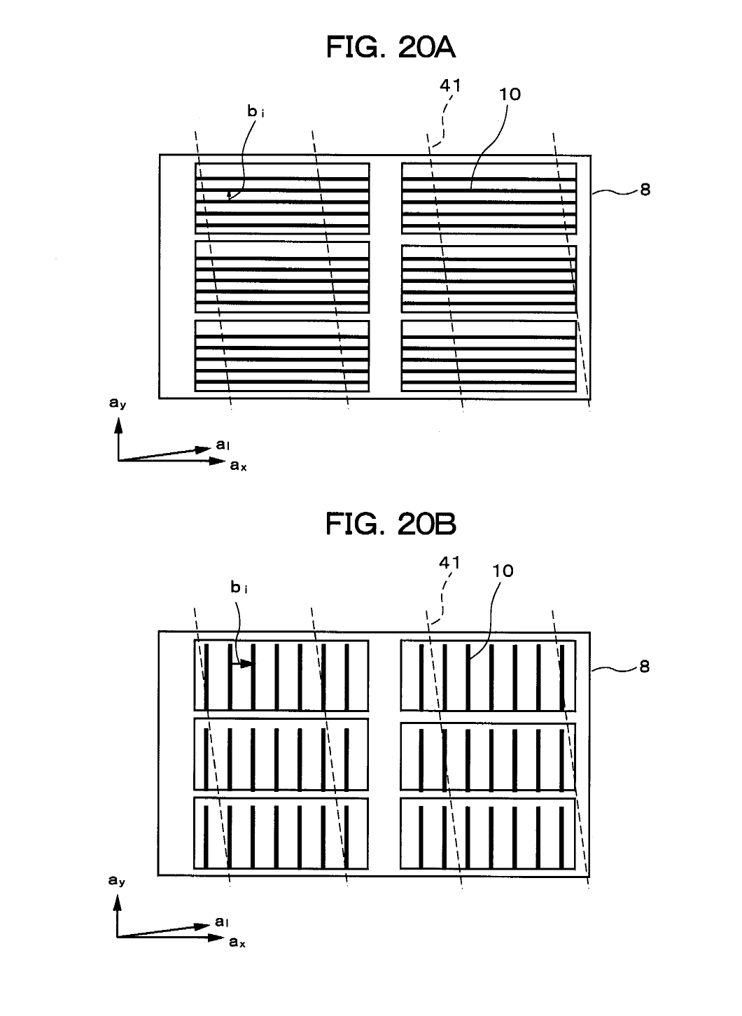

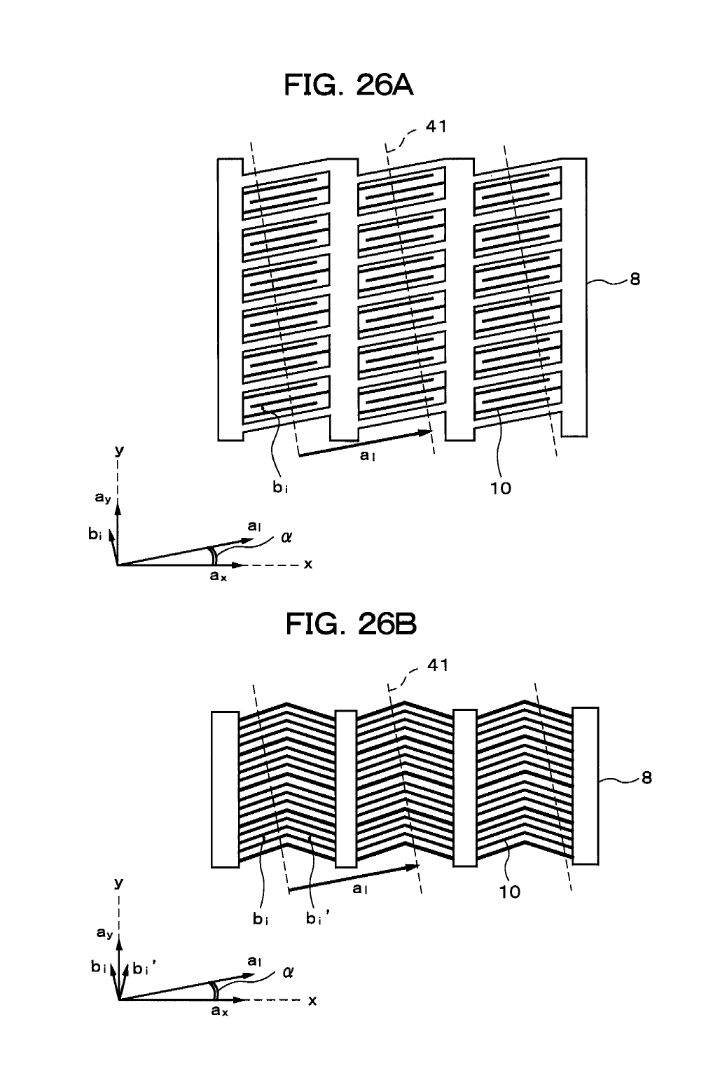

A display device according to a sixth embodiment of the present invention shall next be described. FIG. 26 is a top view showing a pixel structure in an in-plane switching display device according to the present embodiment. FIGS. 20A and 20B are plan views schematically showing a comb-shaped electrode provided to an open part of a pixel.

First, moiré formed in the in-plane switching display device shall be described using FIGS. 20A and 20B. FIGS. 20A and 20B show a pixel structure of a display panel. The display panel is composed of a plurality of pixels (a total of six in the drawings) partitioned into a lattice shape by a black matrix 8. The pixel region is an open part except where the black matrix 8 having light-blocking properties is disposed. The pixels are rectangular. The length of the pixels in a transverse direction of the drawings is larger than the length in a longitudinal direction of the drawings. The display panel thus has a two-dimensional lattice structure, and a structure is used in which a light-direction regulating element having a periodic arrangement structure is layered onto the display panel. In FIGS. 20A and 20B, an interface 41 between a transparent region and a non-transparent region of the light-direction regulating element is shown, and a plurality of comb-shaped electrodes 10 is formed on the pixel. In an in-plane switching mode, the comb-shaped electrodes 10 generate an electric field in a direction substantially parallel to the display surface. In other words, a transverse electric field or an inclined electric field is generated between the teeth of the comb shape so as to intersect in a direction of elongation of the comb-shaped electrodes 10, liquid crystal molecules rotate in the display surface, and a display having a wide viewing angle is therefore possible.

The comb-shaped electrodes 10 block light emitted from a light source. The liquid crystal molecules on the electrode rotate weakly within the display surface even when the comb-shaped electrodes 10 are composed of a transparent material, since. Therefore, transmissivity is low in this portion, and brightness differs on the electrode and between the electrodes. Normally, display quality at electrode end parts of the comb-shaped electrodes decreases due to inferior orientation or disinclination, and light is therefore blocked by a black matrix or another light-blocking material. Therefore, the periodically arranged electrodes are visible in the open part of the pixels, as shown in FIGS. 20A and 20B. The period is smaller than the period of the two-dimensional periodic structure created by the configuration of the pixels. As a result, new moiré stripes are formed by a new short period created by the electrodes provided in the open part of the pixels, and display quality dramatically decreases.

It is assumed that the primitive translation vector of the comb-shaped electrode 10 in the direction arranged in the short period is a primitive translation vector bᵢ. It is also assumed that the angle between the primitive translation vector bᵢ and the direction in which the transparent/non-transparent regions of the light-direction regulating element (primitive translation vector a₁) are arranged is ω. The primitive translation vector a₁ is orthogonal to the interface 41 of the transparent/non-transparent regions of the light-direction regulating element. It is also assumed that the primitive translation vector of the lattice constituting the pixels is a primitive translation vector aₓ, a_{y}. The primitive translation vector aₓ is a vector in the transverse direction of the drawings, and the primitive translation vector a_{y} is a vector in the longitudinal direction of the drawings that is orthogonal to the primitive translation vector aₓ, as shown in FIGS. 20A and 20B.

In FIG. 20B, a direction of elongation of the comb-shaped electrodes is a direction parallel to the primitive translation vector a_{y}, and the primitive translation vector bᵢ is parallel to the primitive translation vector aₓ For this reason, the direction in which the comb-shaped electrodes 10 are arranged in a short period and a direction in which the transparent/non-transparent regions of the light-direction regulating element are periodically arranged are substantially the same direction. In this instance, moiré stripes having a large period are formed. On the other hand, in FIG. 20A, the direction of elongation of the comb-shaped electrodes is a direction parallel to the primitive translation vector a₁, and the primitive translation vector bᵢ is orthogonal to the primitive translation vector aₓ. For this reason, a large angle ω is formed between the direction in which the comb-shaped electrodes are arranged in a short period, and the direction in which the transparent/non-transparent regions of the light-direction regulating element, and moiré stripes are sufficiently reduced to a level that does not cause discomfort to the human eye. The angle is preferably between 80 and 100 degrees. In particular, when the angle ω is 90 degrees, an orthogonal relationship exists between the structural period of the light-direction regulating element and the structural periods of the electrodes. Therefore, the structural periods do not interfere with one another, and moiré stripes are not created. The range of viewing angles can be freely set in accordance with the intended use by changing the width of the light-direction regulating element in the direction perpendicular to the display surface (direction of a normal line).

A configuration of the present embodiment shall be described next using FIGS. 26A and 26B. In the present embodiment, the display panel is an IPS (in-plane switching) transmissive liquid crystal panel, wherein electrodes 10 for controlling the liquid crystal in the open part of the pixels are formed into comb shapes.

In the present embodiment, a pixel is 141 μm in the transverse direction and 141 μm in the longitudinal direction. The pixel is divided into three parts by sub-pixels having the three colors of RGB. Therefore, the sub-pixels have a transverse dimension of 141 μm and a longitudinal dimension of 47 μm. At least one comb-shaped electrode 10 is provided in the sub-pixels. A three-color color filter is provided on a +z direction side, which is a direction perpendicular to the drawings, i.e., on the side of an observer of the display panel. The direction of the stripe pattern of the color filter is periodically arranged into a stripe pattern in a direction perpendicular to the long edges of the pixels. The color scheme of the stripe pattern of the color filter is arranged in the +y direction, for example, in the following sequence: R, G, and B in the +y direction. The coordinate system is established in the same manner as in FIG. 22, wherein the x coordinate is the transverse direction of the drawing, and the y coordinate is the longitudinal direction of the drawing orthogonal to the x coordinate.

The IPS liquid crystal panel improves the aperture ratio. The comb-shaped electrodes are therefore formed in a direction parallel to the long edges of the pixels. As shown in FIG. 26A, three comb-shaped electrodes having a width of 1.5 μm are provided to the open part of the sub-pixels in a direction parallel to the black matrix that forms the long edge of the pixel. Transmissivity decreases at an end part and a curved part of the comb-shaped electrode due to inferior orientation of the liquid crystal molecules or disinclination, and causes optical leakage and the like. Light is therefore blocked by the black matrix 8. For this reason, when viewed from the +z direction, it appears that only the pixel electrodes parallel to the x axis are periodically arranged in the y axis direction in the open part.

The comb-shaped electrodes are thus formed on the pixels. Therefore, a new short period is formed by the electrodes in a direction orthogonal to the direction of elongation of the comb-shaped electrodes 10. It is assumed that the short-period primitive translation vector is bᵢ. A louver in which transparent regions and non-transparent regions are disposed in alternating fashion and that has a one-dimensional period structure is layered on the display panel. The periodic direction of the louver is a direction orthogonal to the interfaces 41 between the transparent regions and non-transparent regions (a direction of the primitive translation vector a₁), and forms an angle α with the x axis direction. In the present embodiment, a short periodic arrangement direction of the comb-shaped electrodes 10 (the direction of the primitive translation vector bᵢ) and a periodic arrangement direction of the louver (the direction of the primitive translation vector a₁) are arranged so as to be orthogonal. The configuration is otherwise the same as the fourth embodiment.

Operations and effects of the present embodiment shall next be described. In the present embodiment, an orthogonal arrangement is established between the short periodic arrangement direction of the comb-shaped electrodes and the direction in which the transparent regions and non-transparent regions of the louver are arranged, causing mutual interference and creating moiré stripes.

In a display panel capable of creating a wide-viewing-angle display such as an IPS, the request for an optimal viewing angle changes according to the intended use. For example, mobile telephones and the like are likely to be used out of doors, in public, or in other places populated by a large number of the general public, and the gaze of other people must be blocked. At such times, it may be preferable to decrease the viewing angle in a specified direction. Therefore, according to the present embodiment, the non-transparent regions are composed of a light-blocking body, whereby the view at or above a certain viewing angle can reliably be blocked. In addition, the range of the viewing angle can be freely set in accordance with the intended use by configuring the louver. Furthermore, high transmissivity can be maintained, moiré can be reduced, and the display quality in the direction in which the viewing angle is not controlled can be improved. Therefore, exceptional display quality can be realized.

In a modified example of the present embodiment, the comb-shaped electrodes are curved into a single-peaked shape, as shown in FIG. 26B. In this instance, a direction in which the transparent regions and non-transparent regions of the layered louver are arranged is positioned along a lateral direction of the drawing substantially parallel to a direction of elongation of the comb shapes. Since the electrodes are curved into a chevron shape, angles of inclination of the electrodes that extend in a lateral direction on both sides of the curved parts are mutually different. For this reason, two short periodic directions are present that are created by the arrangements of the electrode parts having differing angles of inclination. It is assumed that primitive translation vectors that correspond to the two short periods are primitive translation vectors bᵢ, bᵢ. The primitive translation vector bᵢ is configured to be orthogonal to the primitive translation vector a₁, which is the structural periodic direction of the louver. On the other hand, the chevron of the comb-shaped electrode is formed so as to create an angle of 15 degrees or less with the primitive translation vector bᵢ. In such a configuration, the short periodic direction of the comb-shaped electrodes and the periodic direction of the transparent/non-transparent regions of the louver have a range of 75 degrees to 105 degrees. Therefore, moirécreated by the short period of the comb-shaped electrodes and the structural period of the louver is reduced. In particular, curving the electrodes into a chevron shape divides the orientation direction of the liquid crystal into two, and therefore makes the viewing angle region toward the divided directions uniform. As a result, the viewing angle region is not anisotropic in nature, and an exceptional display device can be realized.

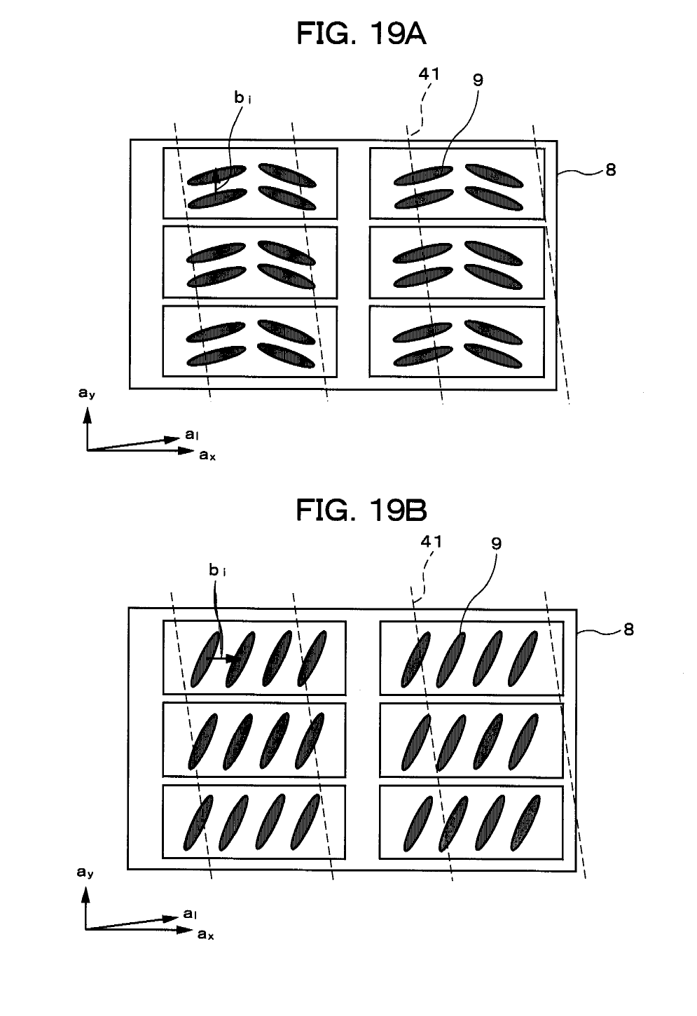

A display device according to a seventh embodiment shall next be described. The display device according to the present embodiment is a liquid crystal display device that uses a perpendicular orientation mode for the liquid crystal molecules. FIGS. 19A an 19B are a plan view schematically showing a pixel structure of a liquid crystal display element, and a schematic view showing a structure that is used to orient liquid crystals and is provided to the open part of the pixels. The configuration of FIG. 19A corresponds to a configuration of the present embodiment, and FIG. 19B is a comparative example.

In the perpendicular orientation mode, a three-dimensional protruding object is provided to the open part of each of the pixels, whereby the orientation of the liquid crystal is divided and a display having a wide viewing angle can be realized. The protruding object for dividing the orientation of a liquid crystal has a transmissivity that is different from that of the surrounding liquid crystals. Therefore, light emitted from the light source is absorbed and a periodic transmissivity distribution is generated in the open part of the pixel. As a result, moiré stripes are formed by the periodicity of a light-direction regulating element and the short periodicity of the protruding object. The periodic transmissivity distribution of the pixels differs from a primitive translational period of the pixels, and therefore must be differentiated.

The display panel is composed of a plurality of pixels (a total of six in the drawings) that are partitioned into a lattice shape by a black matrix 8. The pixel region is an open part except for where the black matrix 8 having light-blocking properties is disposed, as shown in FIGS. 19A and 19B. The pixels are rectangular. The length of the pixels in the transverse direction of the drawings is greater than the length in the longitudinal direction of the drawings. The display panel thus has a two-dimensional lattice structure. A structure is used in which the light-direction regulating element having a periodic arrangement structure is layered on the display panel. The light-direction regulating element is, e.g., a louver having the configuration shown in FIG. 22. An interface 41 between a transparent region and a non-transparent region of the light-direction regulating element is shown in FIGS. 19A and 19B.

A plurality of protruding objects 9 is provided to the open part of the pixels, and the protruding objects 9 are arranged along the longitudinal direction of the drawings at a period that is shorter than the period of the pixels, as shown in FIGS. 19A and 19B. It is assumed that the primitive translation vector, which is a unit of the primitive period of the protruding objects 9 arranged at a short period, is a primitive translation vector bᵢ. It is also assumed that an angle between the one-dimensional arrangement direction orthogonal to the interface 41 between the transparent/non-transparent regions of the light-direction regulating element (the direction of the primitive translation vector a₁) and a direction in which the protruding objects 9 are periodically arranged (the direction of the primitive translation vector bᵢ) is an angle ω. It is assumed that the primitive translation vectors of the two-dimensional lattice constituting the pixels are primitive translation vectors aₓ, a_{y}. The primitive translation vector aₓ is the vector in the transverse direction of the drawings, and the primitive translation vector a_{y} is the vector in the longitudinal direction of the drawings orthogonal to the primitive translation vector aₓ, as shown in FIGS. 19A and 19B.

When the same direction is used for one-dimensional arrangement direction of the transparent/non-transparent regions of the light ray direction controlling element (the direction of the primitive translation vector a₁) and the periodic direction of the transmissivity distribution (the direction of the primitive translation vector bᵢ), i.e., when ω is 0 degrees, the structural period of the light ray direction controlling element and the structural period of the protruding objects interfere with one another, and moiréstripes having a large period are therefore formed. FIG. 19B corresponds to such an instance, wherein moiré stripes having a large period are formed at a ω angle of 10 degrees. On the other hand, ω is 80 degrees in FIG. 19A. When ω thus has a high value, moiré stripes will be sufficiently reduced to a level at which discomfort is not caused to the human eye as long as ω is preferably 80 to 100 degrees. In particular, if the angle ω is 90 degrees and an orthogonal relationship is established between the structural periodic direction of the light ray direction controlling element and the structural periodic direction of the protruding objects, the periodic directions do not interfere with one another, and moiré stripes are not formed. The configuration of the present embodiment corresponds to FIG. 19A.

In a display panel capable of displaying at a wide viewing angle, the demand for an optimal viewing angle changes in accordance with the intended use. For example, mobile telephones and the like are likely to be used out of doors, in public, or in other places populated by a large number of the general public, and the gaze of other people must be blocked. At such times, it may be preferable to decrease the viewing angle in the specified direction. Therefore, according to the present embodiment, the non-transparent regions are composed of a light-blocking body, whereby the view at or above a certain viewing angle can reliably be blocked. In addition, the range of the viewing angles can freely be set in accordance with the intended use by configuring the louver. In particular, in the present embodiment, a high transmissivity can be maintained, moirécan be reduced, and display quality in the direction in which the viewing angle is not controlled can be improved. Therefore, exceptional display quality can be realized.

The present embodiment can be suitably used in a configuration having a structure for shielding or anisotropically modulating light internally, and can reduce moiré caused by a periodic arrangement that includes periodically arranged structures and the absorbing and transmissive regions of the louver.

Examples of modes for liquid crystal panels such as those described above include, in a in-plane switching mode, IPS (in-plane switching), FFS (fringe field switching), and AFFS (advanced fringe field switching). In addition, in a perpendicular orientation mode, examples include MVA (multimedia vertical alignment) which is made into a multi-domain and in which dependence on the viewing angle is reduced, PVA (patterned vertical alignment), and ASV (advanced super view). The invention can also be suitably used in a liquid crystal display panel with a film-compensated TN mode.

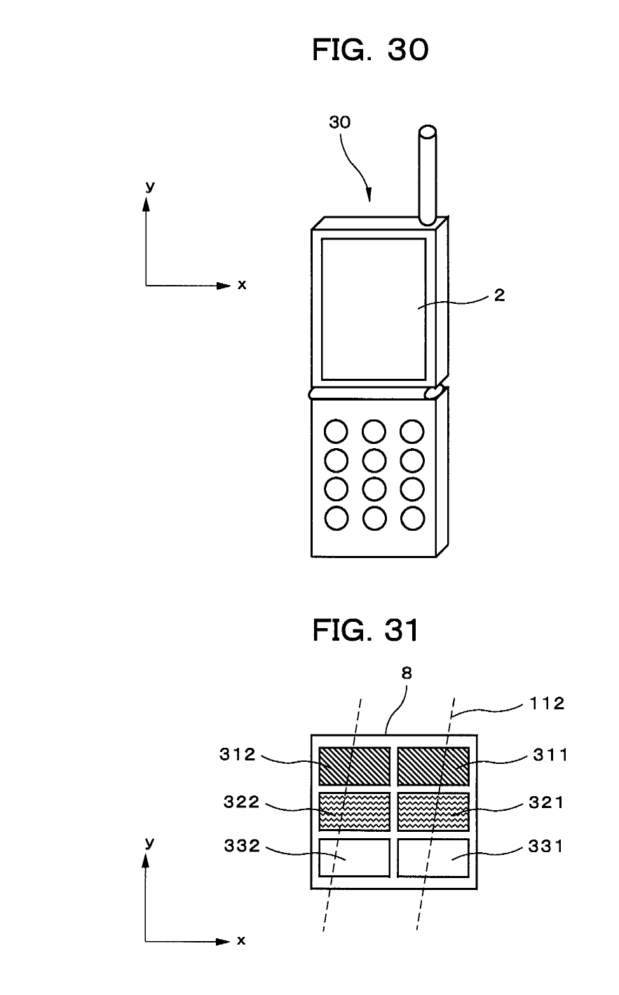

The display device 2 of the present invention is mounted on, e.g., a mobile phone 30, as shown in FIG. 30. The display of the mobile telephone may be used in a transverse direction according to the intended use. In this instance, the display device 2 of the present invention may be rotated by 90 degrees. The mobile telephone functions as a mobile terminal device. Therefore, the device may be used in a location where many people are present, and is exceptionally useful in terms of privacy and security in that the gaze of other people can be blocked.

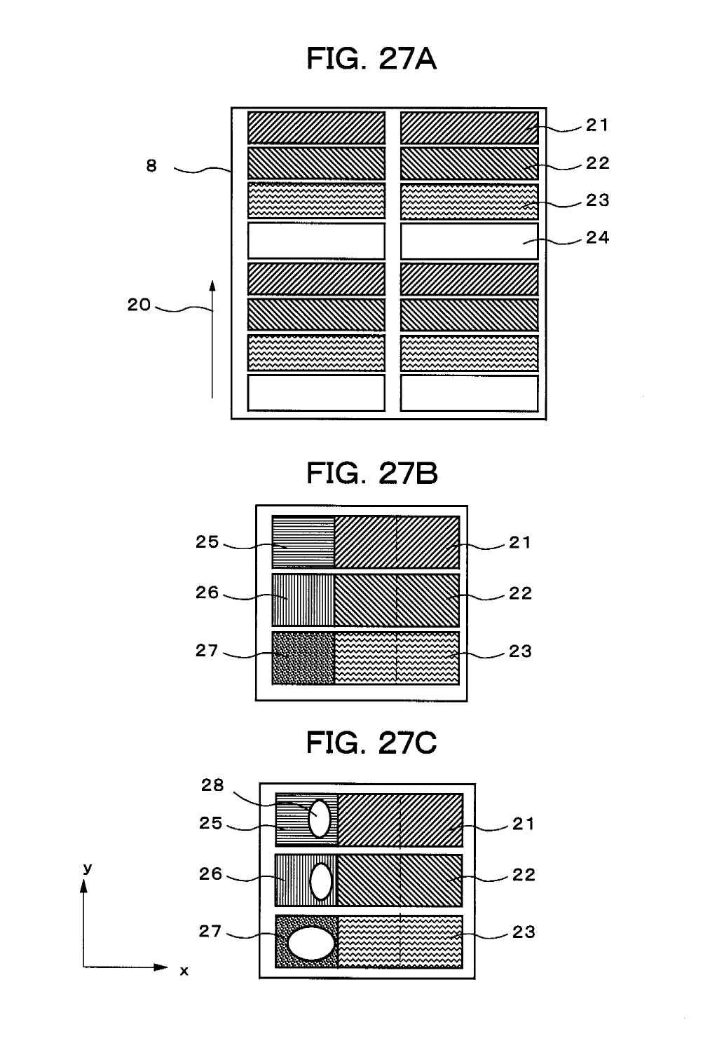

A display device according to an eighth embodiment of the present invention shall be described next. FIG. 27A is a top view showing a pixel arrangement in a transmissive liquid crystal panel of the present embodiment. The description is made using the same coordinate system as FIG. 22 for the sake of simplicity. In other words, in the description, the transverse direction of the page space is an x axis, and the longitudinal direction in the page space is the y axis, which is orthogonal to the x axis.

A plurality of pixels (a total of four in the drawing) is provided in a display surface. A pixel is divided into four parts and provided with four sub-pixels having a color filter of transmissive red (R) 21, green (G) 22, blue (B) 23, and white (W) 24, as shown in FIG. 27A. The sub-pixels are separated by a black matrix 8 having light-blocking properties. The sub-pixels are rectangular. The square-shaped pixels are divided into four equal parts by lines parallel to the x axis. The structural period of the sub-pixels in the x direction is greater than in the y direction. The sub-pixels are equal in size. The sub-pixels having the colors of R, G, B, W are periodically arranged into a striped pattern in a direction perpendicular to the long edges of the rectangle. In other words, a periodic arrangement direction 20 of the stripes is a direction parallel to the y axis. In the present embodiment, the pixels have a transverse dimension of 140 μm and a longitudinal dimension of 140 μm. The sub-pixels having a transverse dimension of 140 μm and a longitudinal dimension of 35 μm are divided into four in the y direction.

Meanwhile, a louver is superposed on the display panel, and a direction in which transparent/non-transparent regions of the louver are one-dimensionally arranged, and a direction in which the stripe pattern of the color filters is periodically arranged are orthogonal to one another or intersect at an angle of 80 to 100 degrees. The configuration is otherwise the same as the fifth embodiment.

An operation and effect of the present embodiment shall next be described. In the present embodiment, the periodic arrangement direction of the stripe pattern of the color filters and the periodic arrangement direction of the transparent/non-transparent regions of the louver are substantially orthogonal and do not interfere with one another. Therefore, color moiré created by the color filters can be reduced. In particular, a white pixel is used, whereby the transmissivity of the panel is improved and luminance can be increased, and the amount of consumed by the backlight can therefore be reduced.

Usually, when the sub-pixels are divided into four, the aperture ratio increases, and a structure shaped as four squares is used, as shown in FIG. 10. However, when a louver is disposed in this configuration, high-magnitude moiré readily forms. In the present embodiment, the structural period in the transverse direction can be increased, and moiré can be reduced. In FIG. 10, the same symbols mark the same structures as in FIG. 27A, and a detailed description shall be omitted.

The transmissive liquid crystal panel of the present embodiment can be applied to a sub-pixel divided into four or more parts. The W color of the sub-pixels can be used at an arbitrary ratio. The R: G: B: W ratio is preferably 1:2:2:1. These values suitably correspond to human visual characteristics. In particular, the effect of the white pixel enables transmissivity to be increased and exceptional display quality to be realized. In the present embodiment, an instance was described in which the display panel comprised pixels having the four colors of red (R), green (G), blue (B), and white (W). However, the configuration is not limited thereto, and the present embodiment can be similarly applied using four other colors. The present embodiment can also be similarly used for a color count other than four. In addition, the sub-pixels can have the following sequence from the +y direction toward the −y direction: R, G, B, W. However, the order is not limited thereto, and the arrangement order may be arbitrary as long as the sub-pixels are divided into the four colors of RGBW.

A first modified example of the eighth embodiment shall next be described. In the present modified example, a pixel is divided into three parts, and is provided with sub-pixels having three color filters of red (R), green (G), and blue (B). A reflective region capable of reflecting outside light is disposed in the sub-pixels. In the pixel of the present modified example, a square pixel region is composed of three sub-pixels divided into three equal parts by straight lines parallel to the x axis direction; and the color filters are disposed in the following sequence from the +y direction to the −y direction: red (R), green (G), and blue (B), as shown in FIG. 27B. The sub-pixels have a rectangular shape whose length in the x axis direction is greater than the length in the y axis direction. The pixel has reflective characteristics in one third of the sub-pixel regions. For example, in the sub-pixel at the upper-most part of the drawing having the red (R), a reflective red (R) 25 color filter is disposed in a reflective region and a transmissive red (R) 21 color filter is disposed in a transmissive region so that the ratio between the surface areas of the two regions is 1:2. The sub-pixels having the green (G) and blue (B) color filters are configured in the same manner. In the present modified example, a region that is transparent and has reflective characteristics is disposed on a TFT (thin film transistor) substrate side, and the color filters are layered over the region. The surface area of the reflective region is preferably changed in accordance with the intended use.

In the present modified example, the color filter used the three colors of red (R), green (G), and blue (B). However, the color filters may use colors whose purity differs in the transmissive regions and reflective regions. A comparison of light emitted from the transmissive region and light emitted from the reflective region yields mutually different brightness and contrast levels. For this reason, transmitted light and reflected light can be treated as separate types of color even when the color belongs to the same system. Therefore, in the present modified example, the transmissive red (R) 21, green (G) 22, and blue (B) 23; and the reflective red (R) 25, green (G) 26, and blue (B) 27 are each treated as separate colors. Accordingly, the display device of the present modified example is configured to use a total of the six colors of the transmissive red (R) 21, green (G) 22, and blue (B) 23; and the reflective red (R) 25, green (G) 26, and blue (B) 27. The configuration is otherwise the same as the fifth embodiment.

According to the first modified example of the eighth embodiment of the present invention, the occurrence of color moiré stripes is reduced by the arrangement of the transparent/non-transparent regions of the louver and the arrangement of colors of the color filter, and a high transmissivity can be maintained in the same manner as in the third embodiment. In particular, since a reflective region is provided, visibility will be good even in environments having strong ambient light.

A second modified example of the eighth embodiment shall next be described. A display panel of the present modified example has a white (W) reflective region in addition to the configuration of the first modified example. One pixel is divided into three parts and is provided with sub-pixels having the three colors of red (R), green (G), and blue (B), as shown in FIG. 27C. The shapes of the pixels and sub-pixels are the same as those in the first modified example. A transmissive region and a reflective region are provided in each of the sub pixels. In the present modified example, the ratio between the transmissive regions and the reflective regions is 2:1. For example, in the sub-pixel at the upper-most part of the drawing having the red, a transmissive red (R) 21 color filter is disposed in a transmissive region, a reflective red (R) 25 color filter is disposed in a reflective region, and the ratio of the surface areas of the two regions is 2:1. A similar configuration is adopted for the other colors. A reflective white (W) is also provided in each of the red (R), green (G), and blue (B) in the reflective region. The surface area of the white (W) can be arbitrarily changed in accordance with the intended use. However, in the present modified example, the blue (B) region is the largest. The configuration is otherwise the same as the fifth embodiment.

According to the present modified example, a reduction can be achieved in the color moiré stripes formed by the arrangement of the transparent/non-transparent regions of the louver and the arrangement of the colors of the color filter, a high transmissivity can be maintained in the same manner as in the third embodiment, and favorable visibility can be provided even in environments having strong ambient light. In particular, since there is a white (W) reflective region, decreases in the luminance of the display screen due to the reflective region can be minimized, and a bright display can be provided. The blue (B) readily appears dark to the human eye. Therefore, a greater effect will be produced by making the reflective region of the white (W) larger than those of the red (R) and green (G).

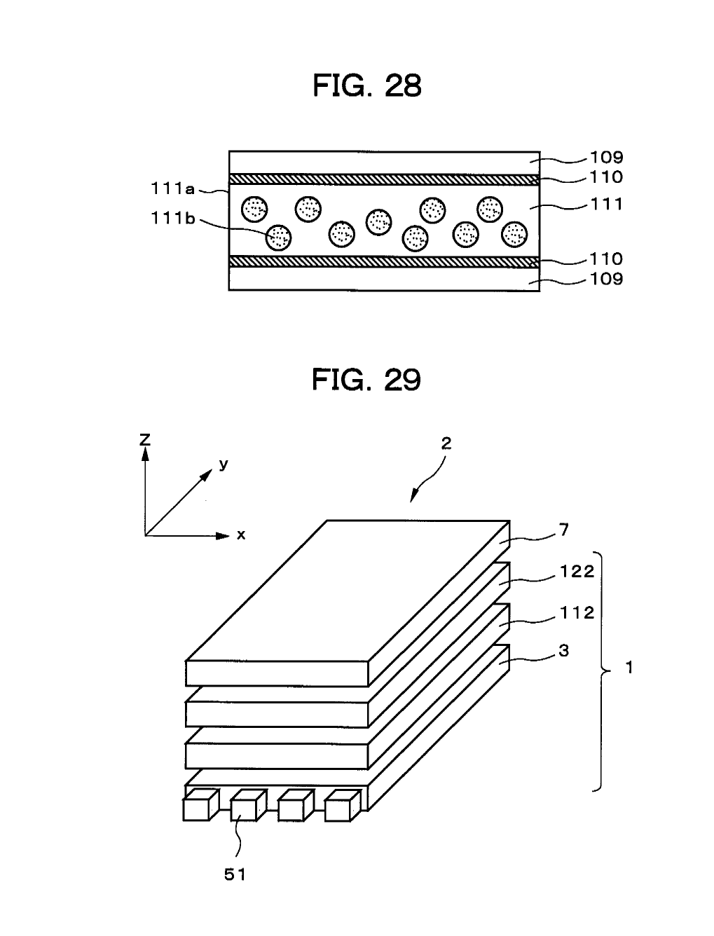

A display device according to a ninth embodiment of the present invention shall be described next. FIG. 28 is a sectional view showing a transparent/scattering switching element used in the present embodiment; and FIG. 29 is a perspective view showing the display device according to the present embodiment.

In a display device 2 of the present embodiment, a transparent/scattering switching element 122 is provided between the louver 112 and the transmissive liquid crystal panel 7 of the fourth embodiment of the present invention, as shown in FIG. 29. In other words, the light source device 1 comprises the light guide plate 3; the light source 51 provided to a side surface of the light guide plate 3; the louver 112 that is a light-direction regulating element disposed on a front surface of the light guide plate 3, i.e., on the side of the observer; and the transparent/scattering switching element 122 disposed on the side of the front surface of the louver 112 that faces the observer. In the display device of the present embodiment, the transparent/scattering switching performed by the transparent/scattering switching element 122 can be used to switch between a display mode in which the range of angles at which the display can be seen is made more narrow and the gaze of onlookers is blocked, and a display mode in which the range of angles at which the display can be seen is widened and the screen can be seen simultaneously by a plurality of people so that information can be shared with other people.

In the transparent/scattering switching element 122, a transparent substrate 109 is provided; an electrode 110 is provided so as to cover a surface of the transparent substrate 109; and a PDLC (polymer dispersed liquid crystal) layer 111 composed of liquid crystal molecules 111b dispersed in a polymer matrix 111a is provided on the electrode 110, as shown in FIG. 28. Electrodes 110 are provided on the PDLC layer 111, and the transparent substrate 109 is provided on the electrodes 110. The pair of electrodes 110 applies voltage to the interposed PDLC 111 and changes the orientation state of the liquid crystal molecules in the PDLC layer. The PDLC layer 111 is formed by exposing and curing, e.g., a mixture of a light-curing resin and a liquid crystal material. The transparent/scattering switching element 122 transmits incident light without further modification, or scatters and emits the light to the transmissive liquid crystal panel 7. The configuration of the present embodiment is otherwise the same as the eighth embodiment.

The operation of the display device 2 of the present embodiment configured in the above-described manner shall be described next. Light generated by the light source 51 is made incident on the light guide plate 3, is reflected after being propagated within the light guide plate 3, and is made incident on the louver 112. The louver 112 is configured as shown in FIG. 22. As part of light incident on the louver 112, a light beam that has a large angle in relation to the z axis direction is absorbed by the non-transparent regions 112b of the louver 112 in the direction in which the transparent regions 112a and non-transparent regions 112b are periodically disposed in alternating fashion. As a result, light emitted from the surface of the louver 112 has increased directivity. Light emitted from the louver 112 is then made incident on the transparent/scattering switching element 122. The coordinate system of FIG. 29 is established in the same manner as that of FIG. 24.

First, an instance shall be described in which a wide viewing angle display is created. When a wide viewing angle display is to be created, voltage is applied to the PDLC layer 111. For this reason, the PDLC layer 111 is in a state in which the liquid crystal molecules 111b in the polymer matrix 111a are randomly dispersed and incident light is scattered. Therefore, light having high directivity is uniformly scattered by the PDLC layer 111 and dispersed in a wide range of angles. In other words, light whose directivity has been increased by the louver is scattered by the transparent/scattering switching element 122, the directivity thereof is reduced, and the light becomes wide-angle light. Light distributed across a wide range is made incident on the transmissive liquid crystal panel 7, and wide-angle light is emitted without further modification. An image is thus displayed at a wide viewing angle.

An instance shall next be described in which a narrow viewing angle display is to be created. The process when a narrow viewing angle display is to be created is the same as that when a wide viewing angle display is to be created up to the point where light is made incident on the transparent/scattering switching element 122. In the narrow viewing angle display, a predetermined voltage is applied to the PDLC layer 111. Accordingly, the liquid crystal molecules 111b of the PDLC layer 111 that are dispersed in the polymer matrix 111a are oriented and brought into a transparent state. In other words, incident light having high directivity is transmitted without further modification. Therefore, light whose directivity in the y direction has been increased by the louver 112 is emitted from the transparent/scattering switching element 122 in a distributed state in which high directivity is maintained. Light having the highly directed distribution strikes the transmissive liquid crystal panel 7 and is emitted while the high directivity is maintained. An image is thus displayed at a narrow viewing angle.

In the present embodiment thus configured, a reduction is achieved in the moiré created by the structural period of the louver and the structural period of the transmissive liquid crystal panel, high transmissivity is maintained, and the display quality can be improved. In addition, the display can be switched between one that has a wide range of viewing angles and can be viewed simultaneously by a plurality of people, and one that has a narrow range of viewing angles and can be viewed only be the user.

In the present embodiment, a description was given of a configuration in which the transmissive liquid crystal panel, the transparent/scattering switching element, and the louver were arranged in sequence from the direction of the observer. However, the order is not necessarily limited thereto, and the order may be changed to a suitable order in a range having the same effect. For example, a configuration may be adopted in which the transparent/scattering switching element, louver, and transmissive liquid crystal panel are arranged sequentially from the side of the observer. The louver and transparent/scattering switching element may also be fixed in place by an anisotropic dispersion cohesive layer.

A liquid crystal panel having a low dependence on a viewing angle can suitably be used in combination with the light source device of the present embodiment, and grayscale inversion can be minimized when a wide-angle display is used. Examples of such liquid crystal panel modes include IPS (in-plane switching), FFS (fringe field switching), and AFFS (advanced fringe field switching) in an in-plane switching mode. In addition, in a perpendicular orientation mode, examples include MVA (multi-domain vertical alignment) which is made into a multi-domain and in which dependence on the viewing angle is reduced, PVA (patterned vertical alignment), and ASV (advanced super view). A liquid crystal display panel with a film-compensated TN mode can also suitably be used.

The transparent/scattering switching element used in combination with the light source of the present embodiment is not limited to an element having a PDLC layer, and any element may be suitably used as long as the element can switch between a transparent state and a scattering state. Examples of elements that can be used include those using polymer network liquid crystal (PNLC) and those using dynamic scattering (DS). The above-described PDLC layer is in a scattering state when voltage is not being applied, and is in a transparent state when the voltage is being applied. Accordingly, the transparent/scattering switching element does not consume energy while in a state in which incident light is scattered. Therefore, the luminance of the light source device while in the scattering state can be improved because that amount of energy is allotted to the light source of the backlight. A PDLC layer may be used in which a transparent state is created when voltage is not being applied, and a scattering state is created when voltage is being applied. Such a PDLC layer can be obtained through exposure to light and curing while a voltage is applied. Accordingly, voltage does not need to be applied to the PDLC layer in a narrow-view display that is often used in a mobile information terminal, and power consumption can be minimized. A cholesteric liquid crystal, a ferroelectric liquid crystal, or the like may be used for the liquid crystal molecules used in the PDLC layer. These liquid crystals have a memory that allows an orientation state reached while a voltage is being applied to be maintained even when the voltage is no longer being applied. The use of such a PDLC layer allows energy consumption to be reduced.

A display device according to a tenth embodiment of the present invention shall be described next. FIG. 31 is a top view showing a pixel arrangement in a display panel of the present embodiment.

The pixel is composed of sub-pixels arranged in a 2-by-3 configuration, wherein the sub-pixels are partitioned by a black matrix 8, as shown in FIG. 31. In the present embodiment, the pixels have a transverse dimension of 141 μm and a longitudinal dimension of 141 μm, the sub-pixels have a transverse dimension of 70.5 μm and a longitudinal dimension of 47 μm, and the pixels are divided so as to have equal sizes. In other words, normal transverse striped pixels are composed of double-density sub-pixels in the transverse direction. The long edges of the sub-pixels are parallel to the x axis, and the short edges are parallel to the y axis. As a result, a structural period in the x axis direction is greater than a structural period in the y axis direction. The xy coordinates are established in the same manner as FIG. 22. The x axis is the transverse direction of the drawing, and the y axis is the longitudinal direction of the drawing orthogonal to the x axis. It is assumed that a positive direction of the y axis is the upward direction of the drawing, and it is also assumed that the positive direction of the x axis is the rightward direction of the drawing.

The pixel colors are divided into the colors of red (R), green (G), and blue (B), and are periodically arranged into a striped pattern in the direction perpendicular to the long edges of the sub-pixels. In the present embodiment, the colors are arranged in the following sequence from the positive direction of the y axis: red (R), green (G), and blue (B). In the present embodiment, wiring for supplying display signals is provided individually to each of the six divided sub-pixels. Therefore, the sub-pixels can be individually operated. In other words, two sub-pixels that can be controlled individually are provided for each color. The red (R) sub-pixel is composed of red sub-pixels 311, 312; the green (G) sub-pixel is composed of green sub-pixels 321, 322; and the blue (B) sub-pixel is composed of blue (B) sub-pixels 331, 332, as shown in FIG. 31. These six sub-pixels can be operated individually. An interface between a transparent region and a non-transparent region of the louver 112 is shown above the pixel. The configuration is otherwise the same as the third embodiment.

Therefore, in the present embodiment, a reduction is achieved in the moiré stripes caused by the lattice constituting the sub-pixels and the louver, and by the stripes of the color filter and the louver, high transmissivity or high luminance can be maintained, and a wide range of color variation can be realized by the sub-pixels that can be driven separately. The color filter is composed of only three colors. Therefore, a normal color filter can be used, and costs can be reduced.

In the present embodiment, the sub-pixels were arranged in the following sequence from the +y direction: red (R), green (G), blue (B). However, the order is not limited thereto, and an arbitrary order may be used as long as the sub-pixels are divided into the three colors of RGB and are periodically arranged.

Even when there are three or more colors (N colors), the sub-pixels may be arranged in a 2-by-N configuration, and the color filter may be periodically arranged into a striped pattern in the direction perpendicular to the long edges of the sub-pixels. As a result, by using three or more colors, more colors can be realized and gradation can be improved.

The display panel is not limited to a self-luminous display panel, and may also be applied to a reflective display panel, a transmissive display panel comprising a backlight, or a transflective display panel. In a transflective display panel, the ratio of transmissive parts and reflective parts may be arbitrarily set. The display panel may be referred to as a micro-reflective display panel according to the ratio.

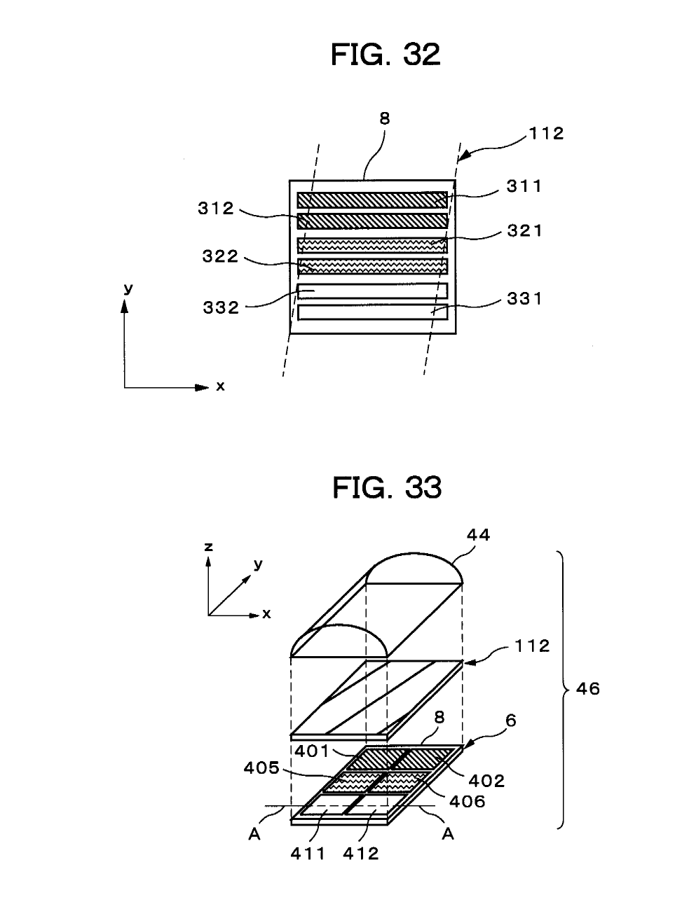

A first modified example of the tenth embodiment shall next be described. FIG. 32 is a top view showing a pixel of a display device according to the first modified example of the tenth embodiment.

The one pixel is composed of six pixels arranged into a 1-by-6 configuration, as shown in FIG. 32. In the present modified example, the pixel has a transverse dimension of 141 μm and a longitudinal direction of 141 μm. The sub-pixels are rectangular, have a transverse dimension of 141 μm and a longitudinal dimension of 23.5 μm, and are divided so as be equal in size. Long edges of the sub-pixels are parallel to the x axis, and short edges are parallel to the y direction. As a result, a structural period in the x axis direction is larger than a structural period in the y direction. It is assumed that the xy coordinate system is established in the same manner as in FIG. 22.

The colors of the pixels are divided into the three colors of red (R), green (G), and blue (B), and are periodically arranged in a striped pattern in a direction perpendicular to the long edges of the sub-pixels. In the present modified example, the colors are arranged in the following sequence from the positive direction of the y axis: red (R), red (R), green (G), green (G), blue (B), blue (B). Wiring for supplying a display signal is provided individually to the sub-pixels that are divided into six parts. Therefore, the sub-pixels can be operated individually. The configuration is otherwise the same as that shown in FIG. 31. Therefore, the same symbols mark the same structures, and descriptions thereof are omitted.

Therefore, in the present modified example, as described above, costs can be minimized due to the use of a regular color filter, and the sub-pixels that can be operated separately allow a wider variety of tone colors to be realized. In particular, the structural period is greatest in the x axis direction. Therefore, moiré stripes can be reduced more than in the tenth embodiment, and, as a result, the pitch of the louver can be increased. Therefore, the aperture ratio of the display device can be increased, and the luminance of the entire panel can be improved so that power consumption can proportionally be reduced. Furthermore, the pitch of the louver is increased, whereby the dependency of the moiré stripes on the viewing angle is reduced as described in the first embodiment.

In the present modified example, the sub-pixels are arranged in the following sequence from the +y direction: red (R), red (R), green (G), green (G), blue (B), blue (B). However, the order is not limited thereto, and the order may be arbitrarily set as long as the sub-pixels are divided into each of the three colors of RGB and are periodically arranged.

When three or more colors (N colors) are used, the pixels may be divided into a 1-by-2N configuration and the color filter may be periodically arranged into a striped pattern in a direction perpendicular to the long edges of the sub-pixels. As a result, by using three or more colors, a wider range of colors can be realized and gradation can be improved.

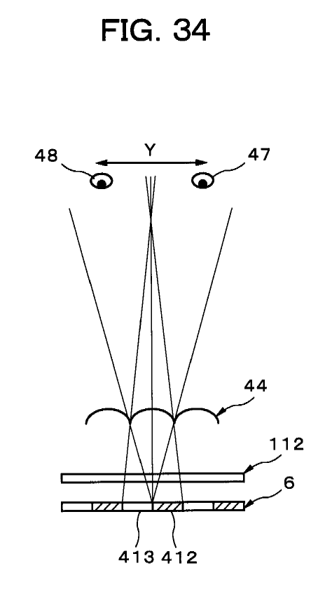

A second modified example of the tenth embodiment of the present invention shall be described next. FIG. 33 is a perspective view showing a three-dimensional image display device according to the present modified example; and FIG. 34 is an optical model diagram showing a cross section of the three-dimensional image display device along line A-A in FIG. 33.

In a three-dimensional image display device 46 according to the present modified example, a cylindrical lens 44 is disposed on the display device of the tenth embodiment, as shown in FIG. 33. In other words, a display panel 6, a louver 112, and the cylindrical lens 44 are layered sequentially in the positive direction of the z axis, and an observer is positioned above the cylindrical lens 44. The xyz coordinate system is established in the same manner as in FIG. 24.

The configuration of a pixel of the display panel 6 is the same as that shown in FIG. 31. The pixel is composed of sub-pixels arranged in a 2-by-3 configuration. The colors of the pixel are divided into the three colors of red (R), green (G), and blue (B), and are periodically arranged into a striped pattern in a direction perpendicular to the long edges of the sub-pixels. The periodic arrangement direction is the y direction. The sub-pixels are composed of red sub-pixels 401, 402, green sub-pixels 405, 406, and blue sub-pixels 411, 412, and the displays of the sub-pixels can be controlled individually, as shown in FIG. 33. The cylindrical lens 44 is a lens having a shape such that a surface on the side of the observer is part of a cylinder. The lens is disposed on the pixels and arranged into a matrix pattern on the display screen. The cylindrical lens 44 arranged in a matrix pattern thus has a one-dimensional structural period and a periodic arrangement direction that is orthogonal to an arrangement direction of the stripes of the color filter.

Light emitted from the pixel strikes the louver 112, as shown in FIG. 34. The widened light beam is absorbed by non-transparent regions of the louver. Light transmitted by transparent regions is therefore emitted while having high directivity. The light emitted from the louver 112 then strikes the cylindrical lens 44. Light that has struck the cylindrical lens 44 is transmitted into the lens, is refracted in accordance with the curvature of the lens, and emitted. Light refracted by the lens is then deflected in the following manner. Light emitted from the RGB sub-pixels on the left side of the drawing and the RGB sub-pixels on the right side of the drawing is deflected by the cylindrical lens 44 and emitted toward the right eye 47 and left eye 48 of the observer, respectively. Accordingly, different information is delivered to the right eye and the left eye. Therefore, a parallax can be added to the information for the right eye and left eye, and the image can be viewed three-dimensionally. It is assumed that the magnified projection width of a single pixel is e, and that the distance between both eyes of the observer is Y. An average measurement of the distance between the eyes of an adult male is 65 mm, with a standard deviation of ±3.7 mm. An average measurement of the distance between the eyes of an adult female is 62, with a standard deviation of ±3.6 mm (see Proc. SPIE Vol. 5291). Therefore, when the three-dimensional image display device according to the present modified example is designed for an average adult, the value of the distance Y between the eyes is suitably set in a range of 62 to 65 mm so that, e.g., Y is 63 mm.

In the present modified example, pixels of the same color within a single pixel are controlled as a single sub-pixel, whereby a regular two-dimensional display can be created. Therefore, a regular two-dimensional display and a three-dimensional image display can be switched between as necessary. In addition, a partially three-dimensional image can be displayed in the display screen. Therefore, the image can be partially accentuated in the direction toward the observer, and a more colorful image can be displayed. The sub-pixels are formed at twice the normal density, and there is no difference in resolution between the display of a three-dimensional image and the display of a two-dimensional image, as shown in FIG. 33. Discomfort when the display is switched can therefore be reduced.

In the prior art, light emitted by a pixel enters a cylindrical lens other than that disposed directly on the pixel, i.e., the adjacent cylindrical lens, and the image quality of a three-dimensional image decreases when a three-dimensional image is displayed. In the present modified example, light whose directivity is controlled by the effect of the louver strikes a lens and does not leak to an adjacent lens. Directivity can be easily controlled by the louver. Therefore, a precise design is possible, and exceptional three-dimensional images can be displayed.

What is claimed is:

1. An optical element comprising:
a two-dimensional lattice sheet composed of transparent regions and non-transparent regions that are periodically arranged in alternating fashion in a first direction and a second direction that intersects the first direction; and
a light-direction regulating element that is superposed on said two-dimensional lattice sheet and is composed of transparent regions and non-transparent regions periodically arranged in alternating fashion in a third direction parallel to a surface of said two-dimensional lattice sheet; wherein
a minimum cycle in said first direction of said two-dimensional lattice sheet is larger than a minimum cycle in said second direction; and
a first primitive translation vector in said first direction whose size is the minimum cycle in said first direction of said two-dimensional lattice sheet, a second primitive translation vector in said second direction whose size is the minimum cycle of said second direction of said two-dimensional lattice sheet, and a third primitive translation vector in said third direction whose size is the minimum cycle in said third direction of said light-direction regulating element are related so that an angle between said third primitive translation vector and said first primitive translation vector is equal to one-half or less of an angle between said first primitive translation vector and said second primitive translation vector.

2. The optical element according to claim 1, wherein
said light-direction regulating element has periodic properties whereby transparent regions and non-transparent regions are arranged in alternating fashion in a fourth direction that intersects said third direction and is parallel to a surface of said two-dimensional lattice sheet;
a minimum cycle in said fourth direction of said light-direction regulating element is larger than a minimum cycle in said third direction; and
an angle between said second primitive translation vector and a fourth primitive translation vector in said fourth direction whose size is the minimum cycle in said fourth direction of said light-direction regulating element is one-half or less of an angle between said first primitive translation vector and said second primitive translation vector.

3. A display device comprising the optical element according to claim 1, wherein
said two-dimensional lattice sheet is a display panel; and
said light-direction regulating element is a louver.

4. The display device according to claim 3, wherein said display panel is a reflective liquid crystal panel or a self-luminous display panel.

5. The display device according to claim 3, wherein
said display device has a backlight; and
said display panel is a transmissive liquid crystal panel or a transflective liquid crystal panel.

6. The display device according to claim 4, wherein said louver and said display panel are arranged in the following sequence from the direction of an observer: louver, display panel.

7. The display device according to claim 5, wherein said louver and said display panel are arranged in the following sequence from the direction of an observer: louver, display panel.

8. The display device according to claim 5, wherein said display panel, said louver, and said backlight are arranged in the following sequence from the direction of an observer: display panel, louver, backlight.

9. The display device according to claim 3, wherein
said display panel has a display region in which pixels are arranged in a matrix;
said transparent regions of said two-dimensional lattice sheet are open parts of the pixels; and
said non-transparent regions constitute a black matrix having light-blocking properties that is formed in said pixels.

10. The display device according to claim 9, wherein
said display panel is composed of sub-pixels having color filters in a display surface;
a striped color pattern is formed by said color filters;
said display panel divided into a lattice by said sub-pixels has two-dimensional translational symmetry in which long edges and short edges of said sub-pixels constitute a period; and
an angle of 80 to 100 degrees is formed by a periodic arrangement direction of said striped pattern and a larger primitive translation vector of two primitive translation vectors having two-dimensional translational symmetry.

11. The display device according to claim 10, wherein a periodic arrangement direction of said striped pattern is orthogonal to said larger primitive translation vector.

12. The display device according to claim 10, wherein said display panel pixels are composed of four or more colors of sub-pixels.

13. The display device according to claim 10, wherein
said display panel has color filters composed of three or more colors in a display surface;
two or more sub-pixels are provided with respect to a single type of color disposed within a single pixel; and
each sub-pixel is individually controlled by an independent display signal.

14. The display device according to claim 3, wherein
said display panel is a liquid crystal panel;
periodically arranged structures are provided for dividing and orienting liquid crystals in open parts of pixels; and
an angle of 80 to 100 degrees is formed by the periodic arrangement direction and said third direction.

15. The display device according to claim 3, wherein
said display panel is an in-plane switching liquid crystal panel;
electrodes are provided in periodic fashion for generating an in-plane field or an out-of-plane field in open parts of pixels; and
an angle of 80 to 100 degrees is formed by the periodic arrangement direction and said third direction.

16. The display device according to claim 3, comprising a transparent/scattering switching element capable of switching between a state of transmitting incident light and a state of scattering incident light.

17. A transmissive liquid crystal display device or transflective liquid crystal display device, wherein said display panel, said transparent/scattering switching element, said louver, and said backlight are arranged in the following sequence from the direction of an observer: display panel, transparent/scattering switching element, louver, backlight.

18. A terminal device comprising the display device according to claim 3.

19. The terminal device according to claim 18, wherein a direction in which said light-direction regulating element regulates light rays is parallel to a straight line connecting both eyes of an observer, or is at an angle of 10 degrees or less in relation to a straight line connecting both eyes of an observer.

20. The terminal device according to claim 18, wherein said terminal device is a mobile telephone, a personal information terminal, a gaming device, a digital camera, a video camera, a video player, a notebook personal computer, a cash dispenser, or a vending machine.
